(19) United States
(12) Patent Application Publication
(10) Pub. No.: US 2013/0002178 A1
(43) Pub. Date: Jan. 3, 2013

(54) INVERTER CONTROL DEVICE, ELECTRIC COMPRESSOR USING INVERTER CONTROL DEVICE, AND ELECTRIC EQUIPMENT

(75) Inventors: Katsumi ENDOU, Shiga (JP); Mitsuhiro FUKUDA, Shiga (JP); Atsushi KODA, Shiga (JP)

(73) Assignee: PANASONIC CORPORATION, Osaka (JP)

(21) Appl. No.: 13/534,928

(22) Filed: Jun. 27, 2012

(30) Foreign Application Priority Data
Jun. 29, 2011 (JP) 2011-144009
May 29, 2012 (JP) 2012-121705

(51) Int. Cl. H02P 6/18

(52) U.S. Cl. 318/400.11

(57) ABSTRACT

An inverter control device controls the operation of a brushless DC motor selsorlessly. A driving controller of the inverter control device switches commutation of switching elements from control based on a position detection commutation signal to control based on a forced synchronization commutation signal if an output voltage of an inverter circuit section is equal to or greater than a preset threshold and a value of a rotational speed detected by the rotational speed detector is equal to or less than a reference value less than a target value of the rotational speed. The output voltage controller of the inverter control device changes the output voltage control signal based on a phase difference detected by a phase difference detector when the driving controller is controlling commutation of switching elements based on the forced synchronization commutation signal.

### BACKGROUND OF THE INVENTION

1. Field of the Invention

The present invention relates to an inverter control device for controlling current application to a brushless DC motor, an electric compressor incorporating inverter control device, and electric equipment such as a refrigerator for household use, including the brushless DC motor drive by the inverter control device.

2. Description of the Related Art

Traditionally, an inverter control device including an inverter circuit is widely used to control the operation of a brushless DC motor. Typically, the brushless DC motor, which is a controlled target, includes a rotor including permanent magnets and a stator constituted by three-phase windings. The inverter control device switches a current application phase of the stator (performs commutation) according to a magnetic pole position of the rotor to generate a rotational (revolving) magnetic field, in the brushless DC motor having the above configuration. Thereby, the rotor of the brushless DC motor gains an output torque. Therefore, in the control of the operation of the brushless DC motor, it is important to obtain a relation of magnetic flux of the rotor with respect to magnetic flux generated by the stator being applied with a current.

There is known a brushless DC motor including a sensor such as a hall element for detecting a magnetic pole position of a rotor. In such a brushless DC motor, the magnetic pole position of the rotor can be detected accurately by the sensor. Therefore, there is no need for an indirect method that uses an induced voltage to detect the magnetic pole position, for example. Since the magnetic pole position of the rotor can be determined directly based on a result of the detection of the sensor, the operation of the brushless DC motor can be controlled easily.

However, in a case where the brushless DC motor is used in a sealed state, for example, in the case of a sealed compressor, or the like, it is not easy to embed the sensor such as the hall element. This is because a failure originating from use environment might occur in the sensor, high reliability of the sensor against leakage of a cooling medium or the like cannot be ensured, or maintenance cannot be carried out easily at the time of a failure because of a unitary construction of the motor and the sensor.

As a solution to the above, in the inverter control device for controlling the operation of the brushless DC motor, various sensorless techniques have been proposed to detect a magnetic pole position of a rotor without use of the sensor such as the hall element. For example, Japanese Laid-Open Patent Application Publication No. Hei. 1-8890 (Sho. 64-8890) discloses a control device of a brushless motor, in which a time when an induced voltage generated in a stator changes is detected to determine a timing at which a current is applied to the stator.

In the above sensorless inverter control device, frequently, 120-degree current application method is used as a method of waveform control. In the 120-degree current application method, during a period of a square wave of an electric angle of 120 degrees, switches of respective phases of the inverter are controlled to be placed in an electric conductive state, while during a period of the remaining electric angle of 60 degrees, the switches are not controlled. During a non-control period (period of the electric angle of 60 degrees), switches of upper and lower arm transistors in the respective phases included in an inverter circuit are OFF. The induced voltage appearing in the terminal of the motor is monitored during the non-control period, and thus the magnetic pole position of the rotor can be detected.

However, the above stated sensorless inverter control device, there is some restriction in its configuration, and it is sometimes difficult to suppress the brushless DC motor from coming out of synchronism (stepping out) and stopping.

For example, in the inverter control device disclosed in Japanese Laid-Open Patent Application Publication No. Hei. 1-8890, the magnetic pole position of the rotor is detected by monitoring the induced voltage. Because of this, in the inverter control device, commutation control of the inverter circuit section is limited to a range in which the induced voltage can be monitored.

In addition, in this inverter control device, if a load change (fluctuation) or a voltage change occurs and causes a rapid rotational change in the brushless DC motor, it becomes difficult to detect a zero cross point in the waveform of the induced voltage. Under this situation, the relative position of the rotor cannot be detected in the brushless DC motor being operating. For this reason, the operation control of the brushless DC motor cannot be continued any more. As a result, the brushless DC motor comes out of synchronism (steps out) and stops.

### SUMMARY OF THE INVENTION

The present invention is directed to solving the problems associated with the prior art, and an object of the present invention is to effectively suppress a brushless DC motor from stepping out and stopping and to implement stable and highly reliable operation control in a sensorless inverter control device which controls the operation of the brushless DC motor.

According to one aspect of the present invention, an inverter control device comprises an inverter circuit section for driving a brushless DC motor which is a three-phase permanent magnet synchronous motor; a rotor position signal generating circuit section which compares an induced voltage of the brushless DC motor to a reference voltage and generates a rotor position signal; and an inverter control section which generates a control signal using the rotor position signal from the rotor position signal generating circuit section and outputs the control signal to the inverter circuit section; wherein the inverter control section includes: an output voltage controller which generates an output voltage control signal for controlling a three-phase voltage output from the inverter circuit section; a rotor position detector for detecting a position of a rotor of the brushless DC motor based on the rotor position signal; a phase difference detector for detecting a phase difference of a phase of the induced voltage with respect to a phase of the output voltage of the inverter circuit section, based on the rotor position signal from the rotor position signal generating circuit section; a position detection commutation controller which generates a position detection commutation signal for commutating a plurality of switching elements included in the inverter circuit section, based on the detected rotor position signal from the rotor position detector; a forced synchronization commutation controller which generates a forced synchronization commutation signal for forcibly commutating the plurality of switching elements, based on a target value of a rotational speed of the brushless DC motor, and the phase difference detected by the phase difference detector; a rotational speed detector for detecting a rotational speed of the brushless DC motor in operation (during operation); and a driving controller for controlling the output voltage of the inverter circuit section based on the output voltage control signal and controlling commutation of the plurality of switching elements based on the position detection commutation signal or the forced synchronization commutation signal; and wherein the driving controller switches the commutation of the plurality of switching elements from control based on the position detection commutation signal to control based on the forced synchronization commutation signal, if the output voltage of the inverter circuit section is equal to or greater than a preset threshold and a detected value of the rotational speed which is detected by the rotational speed detector is equal to less than a reference value less than the target value of the rotational speed; and the output voltage controller changes the output voltage control signal based on the phase difference detected by the phase difference detector, during a period when the driving controller is controlling the commutation of the plurality of switching elements based on the forced synchronization commutation signal.

The output voltage controller may change the output voltage control signal to adjust the phase of the induced voltage to enable the rotor position detector to detect the position of the rotor, if the target value of the rotational speed becomes equal to or less than a preset lower limit value during a period when the driving controller is controlling the commutation of the plurality of switching elements based on the forced synchronization commutation signal; and the driving controller may switch the commutation of the plurality of switching elements from the control based on the forced synchronization commutation signal to the control based on the position detection commutation signal.

The output voltage controller may generate the output voltage control signal to decrease the three-phase voltage output from the inverter circuit section, if the phase difference of the induced voltage which is detected by the phase difference detector is a leading phase.

The output voltage controller may generate the output voltage control signal to increase the three-phase voltage output from the inverter circuit section, if the phase difference of the induced voltage which is detected by the phase difference detector is a lagging phase.

The output voltage controller may generate the output voltage control signal to maintain the three-phase voltage output from the inverter circuit section, if the phase difference of the induced voltage which is detected by the phase difference detector is an intermediate phase.

According to another aspect of the present invention, an electric compressor comprises the above stated inverter control device; the brushless DC motor controlled by the inverter control device; and a compression mechanism for compressing a heat transmission medium.

According to another aspect of the present invention, electric equipment comprises the above stated inverter control device; and the brushless DC motor controlled by the inverter control device.

The above and further objects and features of the invention will more fully be apparent from the following detailed description with reference to accompanying drawings.

### BRIEF DESCRIPTION OF THE DRAWINGS

FIG. 1 is a schematic view showing an exemplary configuration of an inverter control device and a brushless DC motor controlled by the inverter control device according to Embodiment 1 of the present invention.

FIG. 2 is a time chart showing the relationship between control signals and terminal voltages in the inverter control device of FIG. 1.

FIG. 3 is a flowchart showing exemplary control of the brushless DC motor by the inverter control device of FIG. 1.

FIG. 4 is a flowchart showing exemplary forced synchronization commutation control in the control of the brushless DC motor of FIG. 3.

FIG. 5 is a flowchart showing exemplary leading phase detection control in the forced synchronization commutation control of FIG. 4.

FIG. 6 is a flowchart showing exemplary lagging phase detection control in the forced synchronization commutation control of FIG. 4.

FIG. 7 is a flowchart showing exemplary control of a brushless DC motor by an inverter control device according to Embodiment 2 of the present invention.

FIG. 8A is a schematic block diagram showing an exemplary configuration of major components in an electric compressor and a refrigerator including the electric compressor, according to Embodiment 3 of the present invention.

FIG. 8B is a schematic block diagram showing an exemplary refrigeration cycle of the refrigerator of FIG. 8A.

FIG. 9A is a schematic block diagram showing an exemplary configuration of an air-conditioning apparatus according to Embodiment 4 of the present invention.

FIG. 9B is a schematic block diagram showing an exemplary configuration of a laundry machine according to Embodiment 4 of the present invention.

FIG. 10 is a schematic view showing an exemplary configuration of an inverter control device and a brushless DC motor controlled by the inverter control device according to Comparative example.

FIG. 11 is a time chart showing the relationship between control signals and terminal voltages in the inverter control device of FIG. 10.

### DETAILED DESCRIPTION OF THE PREFERRED EMBODIMENTS

Hereinafter, preferred embodiments of the present invention will be described with reference to the drawings. Throughout the drawings, the same or corresponding components are identified by the same reference symbols, and will not be described in repetition.

### Embodiment 1

### Basic Configuration of Inverter Control Device

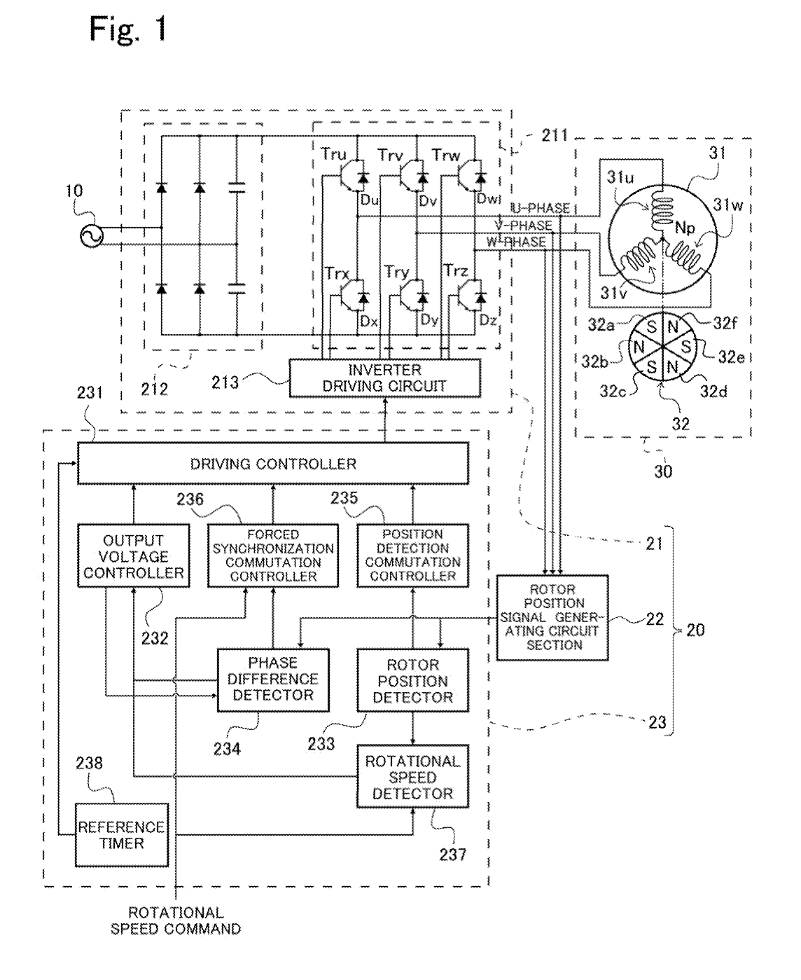

First of all, an exemplary configuration of an inverter control device of Embodiment 1 will be described with reference to FIG. 1.

Turning now to FIG. 1, an inverter control device 20 of the present embodiment is configured to control the operation of a brushless DC motor 30, and includes an inverter circuit section 21, a rotor position signal generating circuit section 22, and an inverter control section 23.

The brushless DC motor 30 (hereinafter simply referred to as DC motor 30), which is to be controlled by the inverter control device 20, is a three-phase permanent magnet synchronous motor. As shown in FIG. 1, the DC motor 30 includes a stator 31 constituted by three-phase windings and a rotor 32 including permanent magnets 32a to 32f.

The stator 31 includes a stator winding 31u corresponding to U-phase, a stator winding 31v corresponding to V-phase, and a stator winding 31w corresponding to W-phase. The rotor 32 has a magnet embedded structure including permanent magnets 32a, 32b, 32c, 32d, 32e and 32f contained therein. The DC motor 30 is configured to generate reluctance torque in addition to magnet torque generated by the permanent magnets 32a to 32f.

The specific configuration of the DC motor 30 is not particularly limited, but known various motors having the configuration of FIG. 1 may be suitably used.

The inverter circuit section 21 in the inverter control device 20 is a circuit for driving the DC motor 30 and electrically connected to a commercial AC power supply 10 and the DC motor 30. In the present embodiment, the inverter circuit section 21 includes a PWM (pulse width modulation) inverter 211, a rectifying/smoothing circuit 212, and an inverter driving circuit 213.

The PWM inverter 211 includes six switching transistors Tru, Trx, Try, Try, Trw and Trz, and six freewheeling diodes Du, Dx, Dv, Dy, Dw and Dz. The switching transistors Tru, Trx, Trv, Try, Trw and Trz are connected together to constitute three-phase bridges. The freewheeling diodes Du, Dx, Dv, Dy, Dw and Dz are connected in parallel with the switching transistors Tru, Trx, Try, Try, Trw and Trz, respectively. Among the switching transistors Tru, Trx, Try, Try. Trw and Trz, the switching transistors Tru and Trx are connected to the stator winding 31u of the DC motor 30 and correspond to U-phase. The switching transistors Try and Try are connected to the stator winding 31v of the DC motor 30 and correspond to V-phase. The switching transistors Trw and Trz are connected to the stator winding 31w of the DC motor 30 and correspond to W-phase.

The PWM inverter 211 supplies a three-phase AC voltage composed of U-phase, V-phase and W-phase to the stator 31 of the DC motor 30, according to the position of the rotor 32. In the present embodiment, a voltage applied from the PWM inverter 211, specifically, the inverter circuit section 21 to the DC motor 30, is referred to as “output voltage.”

The rectifying/smoothing circuit 212 converts an AC current supplied from a commercial AC power supply 10 into a DC current. In the present embodiment, the rectifying/smoothing circuit 212 includes a rectifying circuit composed of four diodes and a smoothing circuit composed of two capacitors. The DC current is supplied from the rectifying/smoothing circuit 212 to the PWM inverter 211.

The inverter driving circuit 213 drives the PWM inverter 211 and controls a magnitude (duty ratio) of the output voltage, commutation associated with ON/OFF of the switching transistors Tru, Trx, Try, Try. Trw and Trz, etc., in response to a control command issued from an inverter control section 23 as described later. Although the inverter driving circuit 213 is schematically shown by a block in FIG. 1, it has a known configuration as the driving circuit.

The specific configuration of the PWM inverter 211, the specific configuration of the rectifying/smoothing circuit 212, and the specific configuration of the inverter driving circuit 213 are in no way limited to the configuration shown in FIG. 1, but may suitably be another known configuration. In addition, the inverter circuit section 21 may have another circuit configuration.

The rotor position signal generating circuit section 22 is provided in a location at which the PWM inverter 211 and the DC motor 30 are connected to each other. The rotor position signal generating circuit section 22 detects voltages (terminal voltages) among three terminals (stator windings 31u, 31v and 31w) of the DC motor 30. The terminal voltage has a waveform containing an induced voltage in each of the phases of the DC motor 30. The rotor position signal generating circuit section 22 compares the induced voltage derived from the terminal voltage to a reference voltage to generate a rotor position signal.

The rotor position signal is generated on the basis of the zero cross point in the waveform of the induced voltage generated in the stator 31. Specifically, a terminal voltage of U-phase, a terminal voltage of V-phase, and a terminal voltage of W-phase are input to the rotor position signal generating circuit section 22. The rotor position signal generating circuit section 22 compares the terminal voltage to a reference voltage in magnitude. A point at which a magnitude relation is reversed, i.e., a polarity is inverted, is the zero cross point. The position of the rotor 32 can be detected on the basis of the zero cross point. Therefore, the rotor position signal generating circuit section 22 may be assumed as a rotor position detection circuit section.

The specific configuration of the rotor position signal generating circuit section 22 is not particularly limited. In the present embodiment, the rotor position signal generating circuit section 22 is constituted by a known comparator (e.g., configuration described in Comparative example as described later), although schematically indicated by one block in FIG. 1. The comparator compares the terminal voltage derived from the induced voltage to the reference voltage to generate the rotor position signal.

The reference voltage can be set based on the output voltage of the inverter circuit section 21. In the present embodiment, the reference voltage can be set as a voltage value which is equal to ½ of a DC voltage output from the rectifying/smoothing circuit 212. The voltage value which is equal to ½ of the DC voltage may be assumed as substantially equal to a voltage value of a neutral point Np of the DC motor 30. Therefore, in the present embodiment, the voltage value of the reference voltage will be referred to as a virtual neutral point voltage value VN.

The inverter control section 23 generates control signals (control commands) using the rotor position signal from the rotor position signal generating circuit section 22 and outputs the control signals to the inverter driving circuit 213 to control the inverter circuit section 21 including the PWM inverter 211.

[Configuration of Inverter Control Section]

Next, an exemplary configuration of the inverter control section 23 will be described specifically with reference to FIG. 1. In the present embodiment, the inverter control section 23 includes a driving controller 231, an output voltage controller 232, a rotor position detector 233, a phase difference detector 234, a position detection commutation controller 235, a forced synchronization commutation controller 236, a rotational speed detector 237, and a reference timer 238.

The driving controller 231 generates drive signals for controlling the six switching transistors Tru, Trx, Trv, Try, Trw and Trz, based on the signals output from the output voltage controller 232, the position detection commutation controller 235 and the forced synchronization commutation controller 236, and outputs the drive signals to the inverter driving circuit 213. The driving controller 231 will be described in detail later.

The output voltage controller 232 generates an output voltage control signal for controlling a three-phase voltage output from the inverter circuit section 21. Specifically, the output voltage controller 232 generates a signal (PWM signal) for performing PWM on the output voltage from the PWM inverter 211 based on a phase difference detection signal from the phase difference detector 234 and/or a rotational speed signal from the rotational speed detector 237 and outputs the PWM signal to the driving controller 231. The driving controller 231 outputs a control command based on the PWM signal to the inverter driving circuit 213. The inverter driving circuit 213 controls the PWM inverter 211 (i.e., inverter circuit section 21) based on the control command, thereby causing the output voltage to be pulse-width modulated. Therefore: in the present embodiment, the output voltage control signal contains the PWM signal.

The rotor position detector 233 detects a magnetic pole position (rotor position) of the rotor 32 of the DC motor 30 based on the rotor position signal from the rotor position signal generating circuit section 22, generates a position signal and outputs the position signal to the position detection commutation controller 235 and to the rotational speed detector 237. For the sake of convenience, the position signal generated in the rotor position detector 233 is differentiated from the rotor position signal generated in the rotor position signal generating circuit section 22 and will referred to as “detection position signal.”

The phase difference detector 234 detects a phase difference of the phase of the induced voltage of the DC motor 30 with respect to the phase of the output voltage of the inverter circuit section 21 (PWM inverter 211), and generates a phase difference detection signal. Specifically, as described above, the rotor position signal generating circuit section 22 detects the terminal voltages of the stator windings 31u, 31v and 31w and generates the rotor position signal. The phase difference detector 234 obtains the phase of the output voltage of the output voltage controller 232, obtains the phase of the induced voltage from the rotor position signal, detects a difference between these phases and generates the phase difference detection signal. The phase difference detector 234 outputs the generated phase difference detection signal to the output voltage controller 232 and to the forced synchronization commutation controller 236.

The position detection commutation controller 235 calculates a timing at which the switching transistors Tru, Trx, Try, Try, Trw and Trz are commutated based on the detected position of the rotor 32 from the rotor position detector 233, and generates a commutation signal for commutating the transistors. The position detection commutation controller 235 outputs the generated commutation signal to the driving controller 231.

The forced synchronization commutation controller 236 calculates a timing at which the switching transistors Tru, Trx, Try, Try, Trw and Trz are commutated, based on the rotational speed command (i.e., target value of the rotational speed) of the DC motor 30 input to the inverter control device 20 and the phase difference detection signal from the phase difference detector 234, and generates a commutation signal for forcibly commutating the switching transistors. The forced synchronization commutation controller 236 outputs the generated commutation signal to the driving controller 231.

The commutation signal generated in the position detection commutation controller 235 and the commutation signal generated in the forced synchronization commutation controller 236 are command signals for commutating the switching transistors Tru, Trx, Trv, Try, Trw and Trz. As described later, the driving controller 231 causes the PWM inverter 211 to be commutated by using the commutation signal generated in the position detection commutation controller 235 or the commutation signal generated in the forced synchronization commutation controller 236. For easier explanation, the commutation signal generated in the position detection commutation controller 235 will be “position detection commutation signal” and the commutation signal generated in the forced synchronization commutation controller 236 will be referred to as “forced synchronization commutation signal.”

The driving controller 231 controls the output voltage based on the output voltage control signal from the output voltage controller 232. The commutation control for the PWM inverter 211 is performed based on either the position detection commutation signal or the forced synchronization commutation signal. As described later, the output voltage controller 232 changes the output voltage control signal based on the phase difference detected by the phase difference detector 234 when the driving controller 231 is controlling the commutation based on the forced synchronization commutation signal.

The driving controller 231 composites the output voltage control signal with either the position detection commutation signal or the forced synchronization commutation signal, to generate the drive signal for controlling the PWM inverter 211, and outputs the drive signal to the inverter driving circuit 213. The drive signal derived from the forced synchronization commutation signal is output as a waveform having a current application angle which is less than 180 degrees. The inverter driving circuit 213 controls ON/OFF of the switching transistors Tru, Trx, Trv, Try, Trw and Trz based on the drive signal from the driving controller 231, thereby controlling the operation of the DC motor 30.

The rotational speed detector 237 detects the rotational speed of the DC motor 30 during at least operation. In the present embodiment, the rotational speed detector 237 calculates the rotational speed during the operation based on the rotor position signal from the rotor position signal generating circuit section 22, calculates a deviation between the calculated rotational speed and the rotational speed command of the DC motor 30, and outputs a signal indicating the deviation to the output voltage controller 232 as the rotational speed signal. Therefore, in the present embodiment, the rotational speed signal generated in the rotational speed detector 237 contains the deviation (rotational speed deviation) between the detected value of the rotational speed during operation and the target value, in addition to the detected value of the rotational speed.

The reference timer 238 is constituted by a known timer circuit, and measures a time to drive the inverter circuit section 21 by the driving controller 231. The reference tinier 238 outputs the measured time information to the driving controller 231.

In the present embodiment, the inverter control section 23 is constituted by a known microcontroller (or microprocessor). Therefore, the driving controller 231, the output voltage controller 232, the rotor position detector 233, the phase difference detector 234, the position detection commutation controller 235, the forced synchronization commutation controller 236, and the rotational speed detector 237 which are constituents of the inverter control section 23 are functions of the microcomputer. They are implemented by operating the microcontroller according to programs stored in a memory (not shown). Note that the driving controller 231, the output voltage controller 232, the rotor position detector 233, the phase difference detector 234, the position detection commutation controller 235, the forced synchronization commutation controller 236, and the rotational speed detector 237, may be configured as known logic circuits, respectively.

[Control Signals of Inverter Control Device]

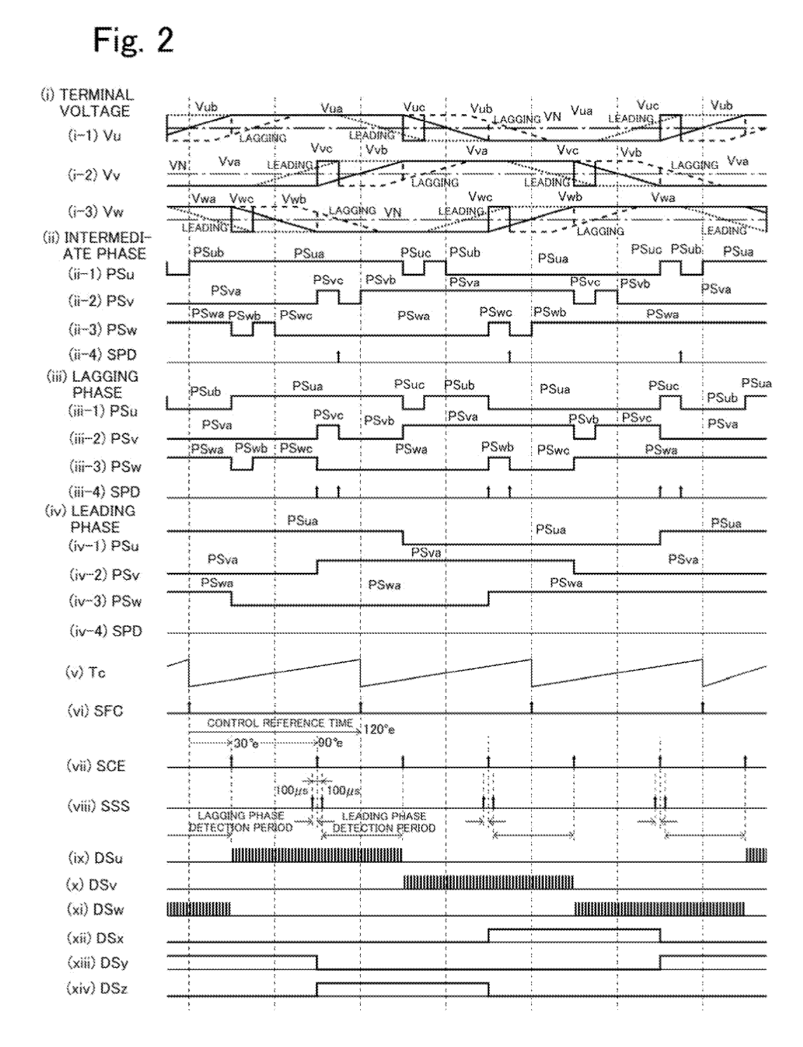

Next, the control signals used by the inverter control device 20 to control the operation of the DC motor 30 will be described with reference to FIG. 2, in conjunction with the waveforms of the terminal voltages detected by the rotor position signal generating circuit section 22.

Turning to FIG. 2, the waveforms indicated by (i) are the waveforms of the terminal voltages Vu, Vv and Vw of the DC motor 30 which are detected by the rotor position signal generating circuit section 22. Specifically, (i-1) indicates the terminal voltage Vu of U-phase, (i-2) indicates the terminal voltage Vv of V-phase, and (i-3) indicates the terminal voltage Vw of W-phase. The waveforms of the terminal voltages Vu, Vv and Vw change with a phase difference of 120 degrees, respectively.

As shown in FIG. 2, the waveform of the terminal voltage Vu is a composite waveform of the voltage (output voltage) Vua fed from the inverter circuit section 21, the induced voltage Vub generated in the stator winding 31u, and a spike voltage Vuc generated during the commutation control, the waveform of the terminal voltage Vv is a composite waveform of the voltage (output voltage) Vva led from the inverter circuit section 21, the induced voltage Vvb generated in the stator winding 31v, and a spike voltage Vvc generated during the commutation control, and the waveform of the terminal voltage Vw is a composite waveform of the voltage (output voltage) Vwa fed from the inverter circuit section 21, the induced voltage Vwb generated in the stator winding 31w, and a spike voltage Vwc generated during the commutation control. The spike voltage Vuc, Vvc or Vwc is the waveform on a pulse generated by electric conduction of any one of the freewheeling diodes Du, Dx, Dv, Dy, Dw and Dz, during the commutation of the switching transistors Tru, Trx, Try, Try, Trw and Trz.

In the waveforms of the terminal voltages Vu, Vv and Vw indicated by (i-1), (i-2) and (i-3), a leading phase is indicated by a dotted line and a lagging phase is indicated by a broken line. One-dotted line indicates the virtual neutral point voltage value VN which is the reference voltage.

The waveforms indicated by (ii), (iii) and (iv) of FIG. 2 are rotor position signals PS generated in the rotor position signal generating circuit section 22. The signals indicated by (ii-4), (iii-4) and (iv-4) of FIG. 2 are phase difference detection signals PSD corresponding to the rotor position signals PS, respectively. As described above, each rotor position signal PS is generated by comparison between the terminal voltage Vu, Vv or VW in each phase to the virtual neutral point voltage value VN (voltage value which is equal to ½ of the DC voltage) which is the reference voltage.

The waveforms indicated by (ii-1), (ii-2) and (ii-3) are rotor position signals PS in an intermediate phase (ii). The waveform indicated by (ii-1) is a rotor position signal PSu in U-phase. The waveform indicated by (ii-2) is a rotor position signal PSv in V-phase. The waveform indicated by (ii-3) is a rotor position signal PSw in W-phase. The signal indicated by (ii-4) is the phase difference detection signal in the intermediate phase detected by the phase difference detector 234.

The waveforms indicated by (iii-1), (iii-2) and (iii-3) are rotor position signals PSu, PSv and PSw, respectively, in a lagging phase. The signal indicated by (iii-4) is the phase difference detection signal in the lagging phase detected by the phase difference detector 234. The waveforms indicated by (iv-1), (iv-2) and (iv-3) are rotor position signals PSu, PSv and PSw, respectively, in a leading phase (iv). The signal indicated by (iv-4) is the phase difference detection signal in the leading phase detected by the phase difference detector 234.

The rotor position signal PS is a composite signal of the output signals PSa, PSb and PSc. The output signals PSa (PSua, PSva and PSwa in FIG. 2) correspond to supply voltages Vua, Vva and Vwa, respectively. The output signals PSb (Sub, PSvb and PSwb in FIG. 2) correspond to periods during which the induced voltages Vub, Vvb and Vwb are compared to the virtual neutral point voltage value VN, respectively. The output signals PSc (PSuc, PSvc and PSwc in FIG. 2) correspond to the spike voltages Vuc, Vvc and Vwc, respectively.

Regarding the phase difference detection signal generated in the phase difference detector 234, when a position detection signal corresponding to a phase of a falling waveform of one of the terminal voltages Vu, Vv and Vw, in a state in which the electric angle of the reference timer 238 is about 90 degrees, is “H,” a lagging phase signal is generated as the phase difference detection signal. When a phase detection signal corresponding to a phase of rising waveform of one of the terminal voltages Vu, Vv and Vw is not “L” during a period from 100 μsec after an electric angle of about 90 degrees of the reference timer 238 up to an electric angle of 120 degrees, a signal different from a leading phase signal is generated as the phase difference signal.

A waveform (v) in FIG. 2 is a measurement value of the reference timer 238. In the present embodiment, the reference timer 238 starts measurement of time in accordance with a rotational speed command (target value of rotational speed) input to the inverter control section 23. At a time point when the time measured by the reference timer 238 reaches a predetermined time, it generates a forced synchronization reference signal (iv) SFC in FIG. 2.

A signal (vii) in FIG. 2 is a forced synchronization commutation signal SCE generated by the forced synchronization commutation controller 236, at specified intervals on the basis oldie forced synchronization reference signal SFC. A signal (viii) in FIG. 2 is a sampling start signal SSS generated by the driving controller 231 on the basis of the forced synchronization reference signal SFC. Waveforms (ix)˜(xiv) in FIG. 2 are drive signals DS generated by the driving controller 231 according to the state of the forced synchronization commutation signal SCE and output to the inverter driving circuit 213.

Among the eight drive signals DS, the drive signal DSu in (ix) of FIG. 2 is used to control the switching transistor Tru, the drive signal DSv in (x) of FIG. 2 is used to control the switching transistor Trv, and the drive signal DSw in (xi) of FIG. 2 is used to control the switching transistor Trw. The drive signal DSx in (xii) of FIG. 2 is used to control the switching transistor Trx, the drive signal DSy in (xiii) of FIG. 2 is used to control the switching transistor Try, and the drive signal DSz (xiv) in FIG. 2 is used to control the switching transistor Trz.

[Operation Control by Inverter Control Device]

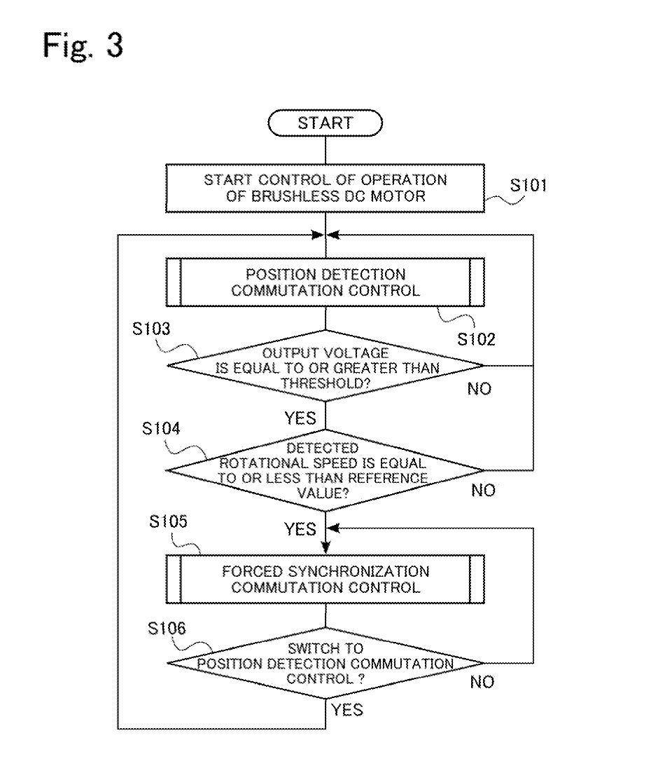

Next, a description will be given of an exemplary operation control of the DC motor 30 which is performed by the inverter control device 20, with reference to FIGS. 3 to 6 in addition to FIGS. 1 and 2. Firstly, a basic operation control performed by the inverter control device 20, will be described with reference to FIG. 3.

Referring to FIG. 3, when the inverter control device 20 starts the operation control of the DC motor 30 (step S101), the driving controller 231 in the inverter control section 23 controls the output voltage of the inverter circuit section 21 based on the output voltage control signal output from the output voltage controller 232, and performs position detection commutation control for the PWM inverter 211 based on the position detection commutation signal output from the position detection commutation controller 235 (step S102).

The control of the output voltage will be described. The output voltage controller 232 generates the PWM signal based on the rotational speed signal from the rotational speed detector 237 and/or the phase difference detection signal from the phase difference detector 234. The PWM signal is output to the driving controller 231 as the output voltage control signal. The driving controller 231 generates a drive signal from the output voltage control signal, and outputs the drive signal to the inverter driving circuit 213 to drive the inverter driving circuit 213, thereby controlling the output voltage. The output voltage is controlled over a continued period during the operation of the DC motor 30, and therefore steps are not specifically depicted in the flowchart of FIG. 3.

Then, the driving controller 231 determines whether or not a duty ratio (output voltage duty ratio or PWM duty ratio) of the output voltage control signal is equal to or greater than a preset predetermined value (threshold) (step S103). If it is determined that the duty ratio is less than the predetermined threshold (NO in step S103), the position detection commutation control continues (process returns to step S102). If it is determined that the duty ratio is equal to or greater than the predetermined threshold (YES in step S103), the driving controller 231 determines whether or not a value of the rotational speed detected by the rotational speed detector 237 is equal to or less than a reference value less than a target value (rotational speed command) of the rotational speed (step S104).

In the present embodiment, the rotational speed signal from the rotational speed detector 237 contains the above stated rotational speed deviation, and therefore it may be determined whether or not the rotational speed deviation is equal to greater than a predetermined value. If it is determined that the detected value of the rotational speed is greater than the reference value (NO in step S104), the position detection commutation control continues (process returns to step S102). If it is determined that the detected value of the rotational speed is equal to or less than the reference value (YES in step S104), the commutation control for the PWM inverter 211 switches from the position detection commutation control based on the position detection commutation signal to the forced synchronization commutation control based on the forced synchronization commutation signal (step S105).

Thereafter, the driving controller 231 may determine whether or not to switch from the forced synchronization commutation control to the position detection commutation control according to various signals, present condition, etc. (step S106). If it is determined that the forced synchronization commutation control should not switch to the position detection commutation control (NO in step S106), the forced synchronization commutation control continues (process returns to step S105). If it is determined that the forced synchronization commutation control should switch to the position detection commutation control (YES in step S106), the forced synchronization commutation control switches to the position detection commutation control (process returns to step S102). After that, this control repeats until the operation control of the DC motor 30 terminates.

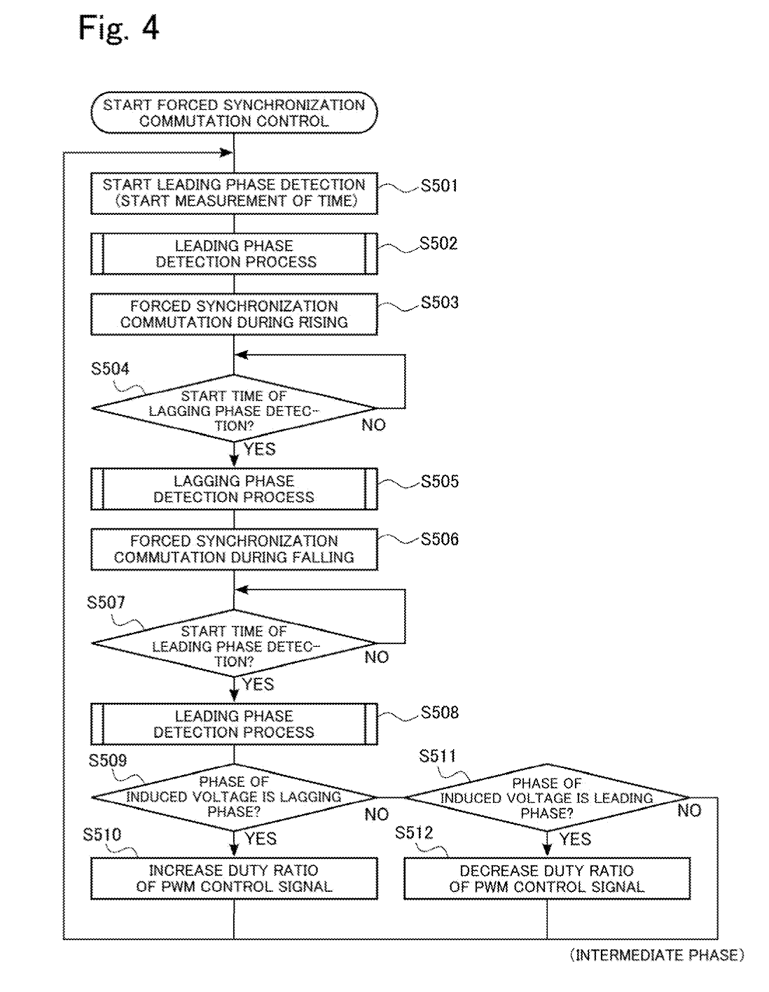

Next, an exemplary forced synchronization commutation control (step S105) in FIG. 3 will be specifically described with reference to FIGS. 4, 5 and 6.

Initially, the driving controller 231 causes the reference timer 238 to start measurement of time in response to the rotational speed command input to the inverter control section 23 (step S501). The timing at which the reference timer 238 starts measurement of time is a time point at which the forced synchronization reference signal (vi) SFC in FIG. 2 is generated. As shown in FIG. 2, the reference timer 238 measures “control reference time” corresponding to the electric angle of 120 degrees with respect to a target frequency. The timing at which the reference timer 238 starts measurement of time conforms to start of a first leading phase detection period.

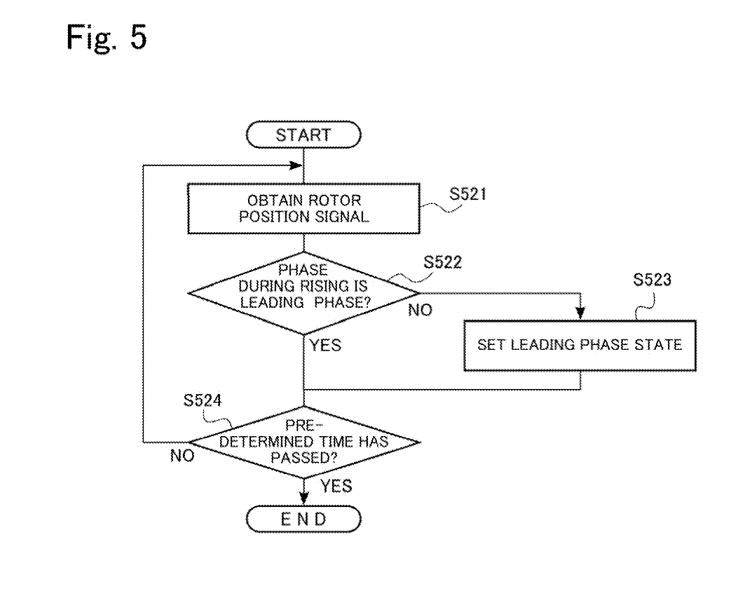

Then, the driving controller 231 causes the phase difference detector 234 to perform a first leading phase detection process (step S502). The leading phase detection process is composed of four steps as shown in FIG. 5.

Initially, the phase difference detector 234 obtains the rotor position signal PS detected by the rotor position signal generating circuit section 22 (step S521), and performs a phase detection process according to the output state of the switching transistor Tru, Trx, Trv, Try, Trw or Trz, i.e., (ii) intermediate phase, (iii) lagging phase, or (iv) leading phase in FIG. 2.

As shown in FIG. 2, during a rising period of the induced voltage of U-phase, V-phase, or W-phase, a rising current-applying phase is in a non-current-applying state during a period corresponding to an electric angle of 60 degrees (60 deg e). Before start of the non-current applying period, the driving controller 231 generates as the drive signal DS, the drive signal (xii) DSx in FIG. 2, the drive signal (xiii) DSy in FIG. 2, or the drive signal (xiv) DSz in FIG. 2. After start of the non-current applying period, the driving controller 231 generates as the drive signal DS, the drive signal (ix) DSu in FIG. 2, the drive signal (x) DSv in FIG. 2, or the drive signal (xi) DSw in FIG. 2.

The phase difference detector 234 determines whether or not the induced voltage of the DC motor 30 is a leading phase when the output voltage of the PWM inverter 211 is a rising waveform (step S522). If it is determined that the induced voltage is the leading phase, the terminal voltages (i) Vu, Vv and Vw in FIG. 2 is not below the virtual neutral point voltage value VN which is the reference voltage, during a leading phase detection period. This state means that the rotor position signal DS is not “L” signal. Therefore, if the phase difference detector 234 detects “L” signal as the rotor position signal DS (NO in step S522), it can be determined that the phase of the induced voltage is not the leading phase state. Then, the phase difference detector 234 sets the leading phase state (step S523).

After the leading phase state is set (after step S523), or when the phase difference detector 234 detects “H” signal as the rotor position signal DS (YES in step S522), the phase difference detector 234 determines whether or not the measurement value (counting) of the reference tinier 238 has reached a predetermined time, i.e., preset commutation time (step S524). In the present embodiment, this commutation time is set as, for example, a time corresponding to an electric angle of 30 degrees (30 deg e). If it is determined that the measurement value (counting) of the reference tinier 238 has not reached the predetermined time yet (NO in step S524), the rotor position signal DS is obtained and determination as to the leading phase repeats (process returns to step S521). On the other hand, if it is determined that the measurement value (counting) of the reference timer 238 has reached the predetermined time (YES in step S524), the process moves to step S503.

Then, the forced synchronization commutation controller 236 generates the forced synchronization commutation signal (vii) SCE in FIG. 2 based on the result of detection (phase difference detection signal) of the phase difference detected by the phase difference detector 234 and the rotational speed command (target value of rotational speed), and outputs the forced synchronization commutation signal (vii) SCE to the driving controller 231. The driving controller 231 generates the drive signal (ix) DSu in FIG. 2, the drive signal (x) DSv in FIG. 2, or the drive signal (xi) DSw in FIG. 2, which is in ON-state, according to the state of U-phase, V-phase or W-phase, and outputs the signal to the inverter driving circuit 213, to perform the commutation operation of the PWM inverter 211. This commutation operation is a forced synchronization commutation operation during rising (step S503).

Then, the driving controller 231 determines whether or not the measurement value of the reference tinier 238 has reached a start time of detection of a lagging phase (step S504). In the present embodiment, for example, this start time is set to a time which is 100 μs before a time corresponding to an electric angle of 90 degrees (90 deg e), as represented by a sampling start signal (viii) SSS in FIG. 2.

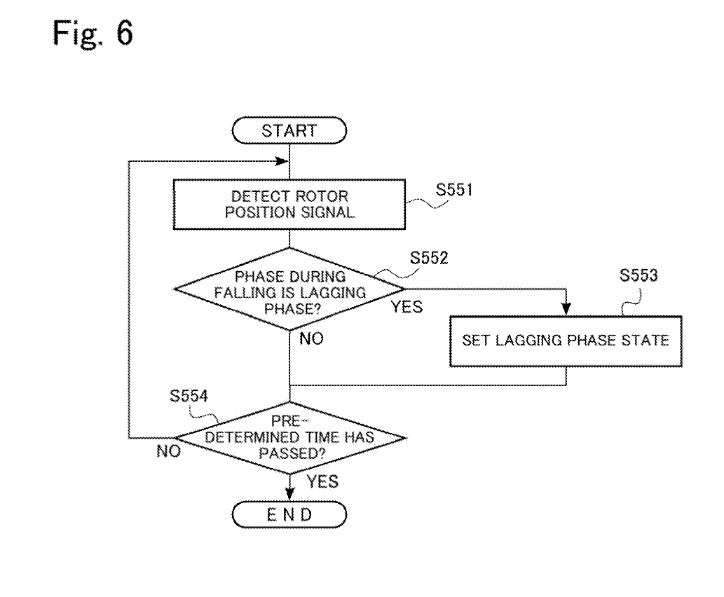

If it is determined that the measurement value of the reference timer 238 has not reached the start time of detection of a lagging phase (NO in step S504), the driving controller 231 repeats determination and stands-by the control operation. On the other hand, if it is determined that the measurement value of the reference timer 238 has reached the start time of detection of the lagging phase (YES in step S504), the driving controller 231 causes the phase difference detector 234 to perform the lagging phase detection process (step S505). This lagging phase detection process is composed of four steps as shown in FIG. 6.

Initially, the phase difference detector 234 obtains a rotor position signal PS detected by the rotor position signal generating circuit section 22 (step S551), and performs the phase detection process based on the output signal of the switching transistors Tru, Trx, Trv, Try, Trw and Trz, i.e., intermediate phase (ii), lagging phase (iii), or leading phase (iv) in FIG. 2.

Then; the phase difference detector 234 determines whether or not the induced voltage of the DC motor 30 is a lagging phase when the output voltage of the PWM inverter 211 is a falling waveform (step S552). If it is determined that the induced voltage is the lagging phase, the terminal voltages (i) Vu, Vv and Vw in FIG. 2 is greater than the virtual neutral point voltage value VN which is the reference voltage, during a lagging phase detection period. This state means that the rotor position signal DS is “H” signal. Therefore, if the phase difference detector 234 detects “H” signal as the rotor position signal DS (YES in step S552), it can be determined that the phase of the induced voltage is the lagging phase state. Then, the phase difference detector 234 sets the lagging phase state (step S553).

After the lagging phase state is set (after step S553), or when the phase difference detector 234 detects “L” signal as the rotor position signal DS (NO in step S552), the phase difference detector 234 determines whether or not the measurement value (counting) of the reference timer 238 has reached a predetermined time, i.e. preset commutation time (step S554). If it is determined that the measurement value (counting) of the reference timer 238 has not reached the predetermined time yet (NO in step S554), the rotor position signal DS is obtained and determination as to the lagging phase repeats (process returns to step S551). On the other hand, if it is determined that the measurement value (counting) of the reference timer 238 has reached the predetermined time (YES in step S554), the process moves to step S506.

Then, the forced synchronization commutation controller 236 generates the forced synchronization commutation signal (vii) SCE in FIG. 2 based on the result of detection (phase difference detection signal) of the phase difference detected by the phase difference detector 234 and the rotational speed command (target value of rotational speed), and outputs the forced synchronization commutation signal (vii) SCE to the driving controller 231. The driving controller 231 generates the drive signal (xii) DSx in FIG. 2, the drive signal (xiii) DSy in FIG. 2, or the drive signal (xiv) DSz in FIG. 2, which is in ON-state, according to the state of U-phase, V-phase or W-phase, and outputs the signal to the inverter driving circuit 213, to perform the commutation operation of the PWM inverter 211. This commutation operation is a forced synchronization commutation operation during falling (step S506).

Then, the driving controller 231 determines whether or not the measurement value of the reference timer 238 has reached a start time of second leading phase detection (step S507). In the present embodiment, this start time is set to a time which is 100 μs after a time corresponding to an electric angle of 90 degrees (90 deg e), as represented by a sampling start signal (viii) SSS in FIG. 2.

If it is determined that the measurement value of the reference timer 238 has not reached the start time of the second leading phase detection (NO in step S507), the driving controller 231 repeats determination and stands-by the control operation. On the other hand, if it is determined that the measurement value of the reference timer 238 has reached the start time of detection of the second leading phase (YES in step S507), the driving controller 231 causes the phase difference detector 234 to perform the second leading phase detection process (step S508). This second leading phase detection process is fundamentally identical to the first leading phase detection process (see FIG. 5), and will not be described in repetition. Note that the phase difference detector 234 determines whether or not a time corresponding to an electric angle of 120 degrees (120 deg e), i.e., control reference time, has passed, instead of the commutation time.

If it is determined that the measurement value of the reference timer 238 has reached the control reference time, the driving controller 231 causes the phase difference detector 234 to perform the determination as to a lagging phase state (step S509). At this time, if the phase of the induced voltage is the lagging phase state, the rotor position signal DS from the rotor position signal generating circuit section 22 continues to be “H” signal immediately before the drive signal (xii) DSx in FIG. 2, the drive signal (xiii) DSy in FIG. 2, or the drive signal (xiv) DSz in FIG. 2, is output.

If it is determined that the phase of the induced voltage is an extremely lagging phase state (YES in step S509), the output voltage controller 232 increases the duty ratio of the PWM signal by a specified value (step S510). Thereafter, the first leading phase detection is initiated (process returns to step S501).

If it is determined that the phase of the induced voltage is not the lagging phase state (NO in step S509), the driving controller 231 causes the phase difference detector 234 to perform the determination as to a leading phase state (step S511). At this time, if the phase of the induced voltage is the leading phase state, the rotor position signal DS from the rotor position signal generating circuit section 22 continues to be “L” signal immediately before the drive signal (ix) DSu in FIG. 2, the drive signal (x) DSv in FIG. 2, or the drive signal (xi) DSw in FIG. 2, is output.

If it is determined that the phase of the induced voltage is an extremely leading phase state (YES in step S511), the output voltage controller 232 decreases the duty ratio of the PWM signal by a specified value (step S512). Thereafter, the first leading phase detection is initiated again (process returns to step S501).

If it is determined that the phase of the induced voltage is neither the lagging phase state nor the leading phase state (NO in step S511), it is an intermediate phase state, and therefore the first leading phase detection is initiated again (process returns to step S501).

As described above, in the present embodiment, during the forced synchronization commutation control, the inverter control section 23 compares the terminal voltage value Vu, Vv, Vw in each phase of the DC motor 30 to the virtual neutral point voltage value VN to determine a phase difference between the phase of the output voltage in each phase of the inverter circuit section 21 and the phase of the induced voltage generated in the stator 31 during the commutation control. If the phase of the induced voltage is retarded with respect to the phase of the output voltage, the inverter control section 23 performs control to increase the output voltage. On the other hand, if the phase of the induced voltage is advanced with respect to the phase of the output voltage, the inverter control section 23 performs control to decrease the output voltage. If the phase of the induced voltage is neither advanced or retarded with respect to the phase of the output voltage, the phase of the induced voltage is maintained at the intermediate phase, and therefore, the zero cross point in the waveform of the induced voltage can be detected.

In other words, during the forced synchronization commutation control, the inverter control section 23 detects the phase of the induced voltage of the DC motor 30, and determines whether the phase of the induced voltage is the lagging phase, the leading phase or the intermediate phase. If it is determined that the phase of the induced voltage is the lagging phase, i.e., the phase of the induced voltage is retarded with respect to the phase of the output voltage of the inverter circuit section 21, the output voltage controller 232 in the inverter control section 23 changes an output voltage control signal so as to increase the output voltage of the inverter circuit section 21. If it is determined that the phase of the induced voltage is the leading phase, i.e., the phase of the induced voltage is advanced with respect to the phase of the output voltage of the inverter circuit section 21, the output voltage controller 232 in the inverter control section 23 changes the output voltage control signal so as to decrease the output voltage of the inverter circuit section 21. If it is determined that the phase of the induced voltage is the intermediate phase, the inverter control section 23 switches from the forced synchronization commutation control to the position detection commutation control as necessary (see step S106 in FIG. 3).

[Senseless Operation Control by Inverter Control Device]

The inverter control device 20 of the present embodiment is configured to control the operation of the DC motor 30 sensorlessly. In the sensorless operation control, if an input rotational speed command (target rotational number) fluctuates or output torque (or load torque) of the DC motor 30 fluctuates, the resulting operating state of the DC motor 30 changes. Such a change in the operating state causes the output voltage of the inverter circuit section 21 to rise up to a limit of favorable control. Therefore, it is more likely that the commutation control performed by the inverter circuit section 21 falls out of a range which can be controlled by monitoring the induced voltage. This might result in a situation in which the operation of the DC motor 30 cannot be controlled well.

For example, the output voltage of the inverter circuit section 21 changes according to the phase of the induced voltage with respect to the phase of the output voltage (or output current). The change in the output voltage causes the output torque of the DC motor 30 to fluctuate. As a result, the output torque becomes excess or deficient, and the operating state of the DC motor 30 changes. The same problems occur in a case where the rotational speed command fluctuates significantly.

As a solution to this, the inverter control device 20 of the present embodiment is capable of switching the DC motor 30 from the position detection commutation control to the forced synchronization commutation control, even when the magnetic pole position (rotor position) cannot be detected easily from the waveform of the induced voltage, when the fluctuation of the input rotational speed command or the fluctuation of output torque of the DC motor 30 occurs (see FIG. 3). This allows the operating state of the DC motor 30 to be continued forcibly. Therefore, a chance that the DC motor 30 comes out of synchronism (steps out) and stops due to a change in the operating state can be reduced effectively. As a result, a stable motor operation is achieved.

In other words, the inverter control device 20 of the present embodiment is capable of continuing the commutation forcibly, by a drive waveform (see drive signal in FIG. 2) of a predetermined frequency, based on a target rotational number (rotational speed command) and an operation rotational number (detected rotational speed) at that point of time, even if an operating state occurs in the DC motor 30, in which the relative position of the rotor 32 cannot be detected by monitoring the induced voltage. Therefore, the operating state of the DC motor 30 can be maintained.

In addition, even in the forced synchronization commutation control, the inverter control device 20 of the present embodiment detects the phase of the induced voltage with respect to the phase of the output voltage (or output current) of the inverter circuit section 21 and determines whether the phase of the induced voltage is the lagging phase, the leading phase or the intermediate phase, and thus, the output voltage can be changed (see FIG. 4). This makes it possible to achieve a stable motor operation in the forced synchronization commutation control.

In the operation control by the forced synchronization commutation control, the zero cross point in the waveform of the induced voltage cannot be detected, and therefore the magnetic pole position cannot be detected. The inverter control device 20 of the present embodiment is capable of switching from the forced synchronization commutation control to the position detection commutation control, at a time point when the phase of the induced voltage becomes the intermediate phase. Because of this, synchronized operation by forced commutation can shift to operation control by sensorless position detection in a stable condition. In addition, since the forced synchronization commutation control shifts to the position detection commutation control when the phase of the induced voltage is the intermediate phase. Therefore, the rotor position signal generating circuit section 22 generates the rotor position signal successfully even just after the forced synchronization commutation control has shifted to the position detection commutation control. Thus, a chance that the DC motor 30 comes out of synchronism and stops can be reduced effectively.

In the forced synchronization commutation control, the output voltage (or output current) of the inverter circuit section 21 can be output with a frequency forcibly synchronized by the synchronization operation. This increases load torque of the DC motor 30 and hence the phase of the induced voltage is retarded with respect to the phase of the output voltage. The fact that the phase of the induced voltage is retarded means that the phase of the output voltage is relatively the leading phase, which can reduce (diminish) magnetic flux of the stator windings 31u, 31v and 31w. Thus, the induced voltage decreases. Therefore, the motor current of the DC motor 30 increases and the output torque increases. As a result, the extent of the operation control of the DC motor 30 can be expanded.

Alternatively, the inverter control device of the present embodiment may have the following configuration.

An inverter control device according to another aspect of the present embodiment includes a brushless DC motor including a rotor provided with permanent magnets and a stator provided with three-phase windings, an inverter circuit section for driving the brushless DC motor, an output voltage control section (output voltage controller) for controlling a three-phase output voltage of the inverter circuit section, a position detection circuit section (rotor position detection circuit section) which compares an induced voltage of the brushless DC motor to a reference voltage generated based on an output voltage of the inverter circuit section, a position detection determiner section (rotor position detector) which outputs a rotor position detection signal from a zero cross point of a waveform of the induced voltage, based on a signal of the position detection circuit section, a position detection commutation control section (position detection commutation controller) which outputs a commutation waveform of the inverter circuit section based on an output signal of the position detection determiner section, a forced synchronization commutation control section (forced synchronization commutation controller) which outputs a waveform of a current-applying angle less than 180 degrees with a predetermined frequency according to a target rotational number of the brushless DC motor, and a phase difference determiner section which detects a phase difference of a phase of the induced voltage with respect to a phase of an output voltage of the inverter circuit section based on a signal of the position detection circuit section, changes a three-phase voltage output of the output voltage control section according to the phase and maintains the phase of the induced voltage with respect to the output voltage of the inverter circuit section, at a predetermined phase, and if the output voltage of the output voltage control section is equal to or greater than a predetermined voltage and the rotational number does not reach a target rotational number, in an operation of position detection commutation, the inverter circuit section switches the position detection commutation to synchronized commutation, the inverter circuit section changes the output voltage according to a change state of the phase of the induced voltage and maintains an operating state of the motor in a synchronized commutation operation.

In accordance with this configuration, since the waveform is output with a predetermined frequency with a current-applying angle less than 180 degrees according to the target rotational number of the brushless DC motor, the inverter circuit section operates by the synchronized commutation. To maintain the phase of the induced voltage with respect to the phase of the output voltage of the inverter circuit section, at the predetermined phase, the output voltage is changed according to a change state of the phase of the induced voltage in the synchronized commutation operation, and thus, the operating state of the motor is maintained. As a result, a stable motor operation can be achieved during the synchronized operation, and the synchronized operation can stably shift to the sensorless position detection operation.

### Embodiment 2

In Embodiment 1, the driving controller 231 is capable of switching the control based on a desired condition when the forced synchronization commutation control shifts to the position detection commutation control (see step S106 in FIG. 3). In contrast, in Embodiment 2, the driving controller 231 is configured to shift from the forced synchronization commutation control to the position detection commutation control based on the rotational speed command. This configuration will be described specifically.

The inverter control device 20 of Embodiment 2 has the same configuration as that of Embodiment 1, as shown in FIG. 1, and will not be specifically in repetition. In the inverter control device 20 of the present embodiment, the output voltage controller 232 changes the output voltage control signal when a target value (rotational speed command) of a rotational speed becomes equal to or less than a preset lower limit value, when the driving controller 231 is controlling the commutation of the PWM inverter 211 based on a forced synchronization commutation signal, i.e., performing the forced synchronization commutation control.

The output voltage control signal is changed in such a manner that the phase of the induced voltage of the DC motor 30 is adjusted so that the rotor position detector 233 can detect the position of the rotor 32 instead of merely changing the PWM signal. When the rotational speed command decreases to a certain degree and the DC motor 30 decreases its speed to a certain degree, a need to maintain the forced synchronization commutation control is maintained reduces. Accordingly, the output voltage controller 232 changes the output voltage control signal and adjusts the phase of the induced voltage to allow the position of the rotor 32 to be detected easily. After the phase of the induced voltage has been adjusted, the driving controller 231 switches the commutation of the PWM inverter 211 from the control (forced synchronization commutation control) based on the forced synchronization commutation signal to the control (position detection commutation control) based on the position detection commutation signal.

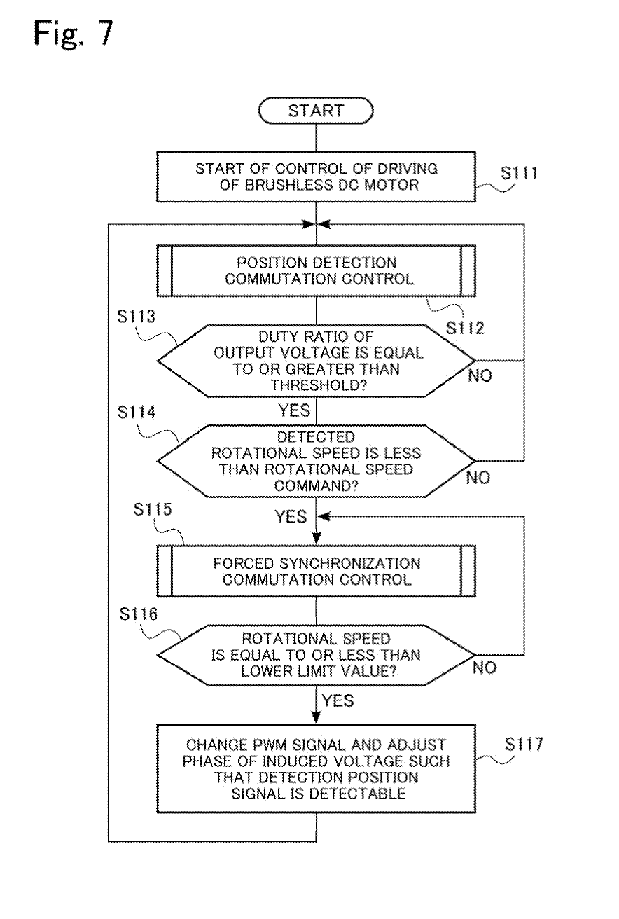

Next, exemplary Operation control for implementing such switching in the inverter control device 20 of the present embodiment will be specified with reference to FIG. 7.

Referring to FIG. 7, when the inverter control device 20 initiates the operation control of the DC motor 30 (step S111), the driving controller 231 controls the output voltage of the inverter circuit section 21 based on the output voltage control signal output from the output voltage controller 232, and performs position detection commutation control for the PWM inverter 211 based on the position detection commutation signal output from the position detection commutation controller 235 (step S112).

Then, the driving controller 231 determines whether or not the duty ratio of the output voltage control signal is equal to or greater than a preset predetermined value (threshold) (step S113). If it is determined that the duty ratio is less than the threshold (NO in step S113), the driving controller 231 continues the position detection commutation control (the process returns to step S112). If it is determined that the duty ratio is equal to or greater than the threshold (YES in step S113), the driving controller 231 determines whether or not the value of the rotational speed which is detected by the rotational speed detector 237 is equal to or less than a reference value which is less than the target value (rotational speed command) of the rotational speed (step S114).

If it is determined that the detected value of the rotational speed is greater than the reference value (NO in step S114), the driving controller 231 continues the position detection commutation control (process returns to step S112). On the other hand, if it is determined that the detected value of the rotational speed is equal to or less than the reference value (YES in step S114), the driving controller 231 switches the commutation control for the PWM inverter 211 from the position detection commutation control based on the position detection commutation signal to the forced synchronization commutation control based on the forced synchronization commutation signal (step S115).

Then, the driving controller 231 determines whether or not the rotational speed command becomes equal to or less than a lower limit value (step S116). This lower limit value is suitably set depending on the kind, application, use condition, etc., of the DC motor 30, and is not particularly limited. If it is determined that the rotational speed command is greater than the lower limit value (NO in step S116), the driving controller 231 repeats the forced synchronization commutation control (process returns to step S115). If it is determined that the rotational speed command is equal to or less than the lower limit value (YES in step S116), the output voltage controller 232 changes the PWM signal (output voltage control signal) and adjusts the phase of the induced voltage so that the rotor position signal can be detected (step S117). Then, the driving controller 231 switches the forced synchronization commutation control to the position detection commutation control (process returns to step S112) and repeats this control until the operation control of the DC motor 30 terminates.

Thus, in the inverter control device of the present embodiment, when the target rotational number becomes equal to or less than a predetermined rotational number (lower limit value) during the operation of the brushless DC motor under control of the forced synchronization commutation control section (forced synchronization commutation control), the output voltage is changed so that the signal of the rotor position detected by the position detection determiner section (rotor position detector) reaches the phase oldie detectable induced voltage, and then the forced synchronization commutation operation shifts to the operation under control of the position detection commutation control (position detection commutation controller).

This allows the output voltage of the inverter circuit section to change according to the output voltage of the inverter circuit section or the phase of the induced voltage. Because of this, the driving control section (driving controller) can determine that the zero cross point of the induced voltage becomes a phase which can be detected, and synchronized operation by forced commutation can shift to operation control by sensorless position detection in a stable condition.

### Embodiment 3

In Embodiment 1 or 2, the inverter control device 20 controls the operation of the DC motor 30 sensorlessly. In Embodiment 3, a description will be specifically given of an electric compressor including the inverter control device 20 of Embodiment 1 or 2 and the DC motor 30 controlled by the inverter control device 20, and a refrigerator including the electric compressor.

[Exemplary Configuration of Electric Compressor]

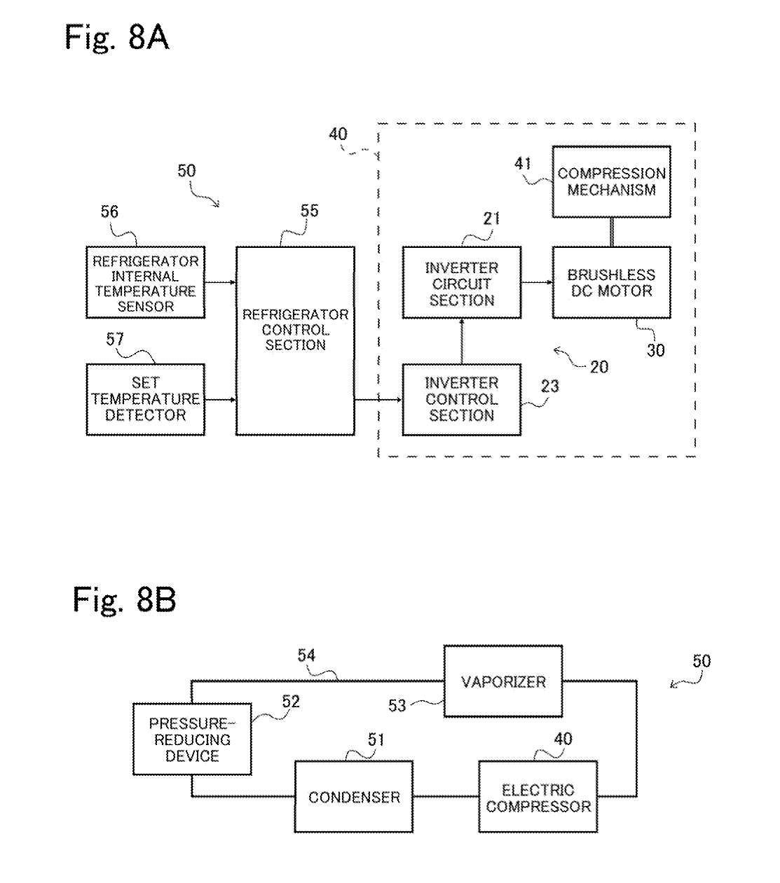

The inverter control device 20 of Embodiment 1 or 2 is suitably applied to the electric compressor included in the refrigerator. This electric compressor will be described with reference to FIG. 8.A.

Referring to FIG. 8A, the electric compressor 40 includes the inverter circuit section 21 of Embodiment 1 or 2, the inverter control section 23 of Embodiment 1 or 2, the DC motor 30 of Embodiment 1 or 2, and a compression mechanism 41. The inverter control device 20 includes the inverter circuit section 21, the inverter control section 23, and the rotor position signal generating circuit section 22 (not shown). The operation of the DC motor 30 is controlled by the inverter control device 20. In the present embodiment, a refrigerator 50 includes the electric compressor 40. In FIG. 8A, the inverter control device 20, the DC motor 30, and the compression mechanism 41, which constitute the electric compressor 40, are represented by blocks and are surrounded by a broken line to depict the electric compressor 40.

The compression mechanism 41 is a known mechanism which suctions and compresses a heat transmission medium such as a cooling medium and discharges the heat transmission medium. In the present embodiment, as the compression mechanism 41, for example, a scroll-type compressor device is used. In the present embodiment, the compression mechanism 41 and the DC motor 30 are arranged coaxially in series and have a unitary configuration. The compression mechanism 41 is configured to operate according to the rotation of the DC motor 30. The inverter control device 20, the DC motor 30, and the compression mechanism 41 are accommodated into a casing which is not shown. The electric compressor 40 may include known components other than the inverter control device 20, the DC motor 30, and the compression mechanism 41.

Since the electric compressor 40 of the present embodiment includes the inverter control device 20 of Embodiment 1 or 2, the operation of the DC motor 30 can be controlled with higher reliability. Therefore, performance of the electric compressor 40 can be improved.

[Schematic Configuration of Refrigerator]

The electric compressor 40 having the above configuration is applied to the refrigerator 50. The refrigerator 50 will be described specifically with reference to FIGS. 8A and 8B.

Referring to FIG. 8B, the refrigerator 50 of the present embodiment includes the electric compressor 40 of FIG. 8A, a condenser 51, a pressure-reducing device 52, a vaporizer 53, a pipe 54, etc. In FIG. 8B, as in the example of FIG. 8A, the electric compressor 40, the condenser 51, the pressure-reducing device 52, and the vaporizer 53 are schematically represented by blocks.

The electric compressor 40 compresses the cooling medium to generate a high-temperature and high-pressure gaseous cooling medium. The condenser 51 cools the cooling medium to form liquid. The pressure-reducing device 52 is constituted by, for example, capillary tube, and reduces the pressure of the liquefied cooling medium (liquid cooling medium). The vaporizer 53 vaporizes the cooling medium to generate a low-temperature and low-pressure gaseous cooling medium. The electric compressor 40, the condenser 51, the pressure-reducing device 52, and the vaporizer 53 are coupled together annularly in this order, by means of the pipe 54 through which the cooling medium flows, thus constructing a refrigeration cycle.

As shown in FIG. 8A, in addition to the refrigeration cycle shown in FIG. 8B, the refrigerator 50 includes a refrigerator control section 55, a refrigerator internal temperature sensor 56, a set temperature detector 57, a body casing including a refrigeration chamber (not shown), a freezing chamber (not shown), an ice compartment (not shown), and others, a blower for blowing air in the interior of the refrigeration chamber, an operating unit operated by a user, etc. The refrigerator control section 55 controls the operation of the refrigerator 50. The refrigerator internal temperature sensor 56 detects a temperature in the interior of the refrigeration chamber, etc. The set temperature detector 57 detects an internal temperature (set temperature) set in the refrigerator 50.

The configurations of the condenser 51, the pressure-reducing device 52, the vaporizer 53, the pipe 54, the refrigerator control section 55, the refrigerator internal temperature sensor 56, the set temperature detector 57, the body casing, the blower, the operating unit, etc., are not limited but known configurations may be suitably used. The refrigerator 50 may include components in addition to the above.

An exemplary operation of the refrigerator 50 (refrigeration cycle) shown in FIG. 8B will be specifically described. The electric compressor 40 compresses the gaseous cooling medium and discharges the compressed gaseous cooling medium to the condenser 51. The condenser 51 cools the gaseous cooling medium to generate the liquid cooling medium. The liquid cooling medium passes through the pressure-reducing device 52, and is sent to the vaporizer 53. The vaporizer 53 vaporizes the liquid cooling medium by depriving heat from its surrounding area. The resulting gaseous cooling medium returns to the electric compressor 40. The electric compressor 40 compresses the gaseous cooling medium and discharges the compressed gaseous cooling medium to the condenser 51 again.

The refrigerator 50 of the present embodiment has the above stated refrigeration cycle. The operation of the electric compressor 40 constituting refrigeration cycle is controlled by the inverter control device 20 of Embodiment 1 or 2. Thereby, reliability of the electric compressor 40 is improved, and hence the refrigeration cycle can be operated well. Therefore, goods preserving temperature in the refrigerator, and others, can be stabilized, and hence goods can be stored with higher reliability.

Although the refrigerator 50 of the present embodiment is a household refrigerator, it may include a showcase in which food and others are displayed, goods storage device for storing drugs, medicine, or chemical goods, etc.

[Exemplary Operation Control of Refrigerator]

Next, exemplary operation control of the refrigerator 50 of the present embodiment will be specifically described with reference to FIG. 5A.

As shown in FIG. 8A, the refrigerator internal temperature sensor 56 is configured to detect an internal temperature and output a detection signal to the refrigerator control section 55, and the set temperature detector 57 is configured to detect an internal temperature and output a detection signal to the refrigerator control section 55. In the present embodiment, the set temperature of the refrigerator 50 detected by the set temperature detector 57 is, for example, minus 16 degrees C. when the set internal temperature is “weak,” minus 18 degrees C. when the set internal temperature is “medium,” and minus 20 degrees C. when the set internal temperature is “intense.”

The refrigerator control section 55 decides the rotational number of the DC motor 30 constituting the electric compressor 40, based on a signal from the refrigerator internal temperature sensor 56 and a signal from the set temperature detector 57, and outputs a rotational speed command to the inverter control section 23. The inverter control section 23 outputs a drive signal to the inverter circuit section 21 to operate the electric compressor 40 in accordance with the rotational speed command. The inverter circuit section 21 operates the DC motor 30 based on the drive signal. Thus, under control of the refrigerator control section 55, the operation of the electric compressor 40 is controlled.

The refrigerator control section 55 determines a magnitude of a difference (internal temperature deviation) between the internal temperature detected by the refrigerator internal temperature sensor 56 and the set temperature detected by the set temperature detector 57, i.e., a degree of deviation between the set temperature and an actual internal temperature. According to the magnitude of the internal temperature deviation, the refrigerator control section 55 generates a rotational speed command for controlling the operation of the electric compressor 40, and outputs the rotational speed command to the inverter circuit section 21.

Specifically, if the difference (internal temperature deviation) between the internal temperature detected by the refrigerator internal temperature sensor 56 and the set temperature detected by the set temperature detector 57 is equal to lower than minus 2 degrees C. the refrigerator control section 55 generates a rotational speed command for stopping the operation of the electric compressor 40, and outputs the rotational speed command to the inverter control section 23. If the internal temperature deviation is equal to lower than plus 2 degrees C., the refrigerator control section 55 generates a rotational speed command for operating the electric compressor 40, at a rotational speed of 1600 r/m, and outputs the rotational speed command to the inverter control section 23. If the internal temperature deviation is equal to lower than plus 6 degrees C., the refrigerator control section 55 generates a rotational speed command for operating the electric compressor 40, at a rotational speed of 3600 r/m, and outputs the rotational speed command to the inverter control section 23. If the internal temperature deviation is higher than plus 6 degrees C., the refrigerator control section 55 generates a rotational speed command for operating the electric compressor 40, at a rotational speed of 4200 r/m, and outputs the rotational speed command to the inverter control section 23.

The set temperature will be specifically described. If the set internal temperature is “medium,” the set temperature is minus 18 degrees C. If the interior has been cooled to minus 20 degrees C. the internal temperature deviation determined by the refrigerator control section 55 is minus 2 degrees C. Therefore, the refrigerator 50 is normally controlled. The refrigerator control section 55 generates a rotational speed command for stopping the operation of the electric compressor 40, and outputs the rotational speed command to the inverter control section 23.

It is supposed that under the normal control state, the internal temperature rises due to the fact that the user opens the door of the refrigerator 50, for example. For example, if the internal temperature deviation is higher than plus 6 degrees C., the refrigerator control section 55 generates a rotational speed command for operating the electric compressor 40, at a rotational speed of 4200 r/m, and outputs the rotational speed command to the inverter control section 23.

When the electric compressor 40 is operating at a speed as high as 4200 r/m, a cooling operation load placed on the refrigerator 50, is higher as an outside temperature is higher. So, the inverter control section 23 switches the sensorless operation control (position detection commutation control) to the forced synchronization commutation control, in order to maintain the rotational number of the electric compressor 40 (rotational number of the DC motor 30).

At this time, the phase difference detector 234 in the inverter control section 23 detects an induced voltage phase with respect to an output voltage phase of the inverter circuit section 21 based on an output signal of the rotor position signal generating circuit section 22. If the detected phase is a leading phase, the output voltage controller 232 reduces the duty ratio of the PWM signal (output voltage control signal) by a specified value. Thus, the driving controller 231 outputs to the inverter driving circuit 213, a drive signal for reducing the output voltage of the inverter circuit section 21. In response to this drive signal, the inverter circuit section 21 reduces the output voltage. Therefore, torque output from the DC motor 30 is reduced. As a result, the electric compressor 40 is operation-controlled in an intermediate phase.

If the induced voltage phase is the intermediate phase at a time point when the sensorless operation control switches to the forced synchronization commutation control, the output voltage controller 232 does not change the duty ratio of the PWM control signal, and therefore, the output voltage of the inverter circuit section 21 is held at a constant value.

If cooling of the interior of the refrigerator 50 in the operating state in the intermediate phase proceeds, a cooling operation load placed on the refrigerator 50 reduces. Thus, the output torque of the DC motor 30 is increased with respect to the load, and therefore the phase detected by the phase difference detector 234 is a leading phase. So, the output voltage controller 232 reduces the duty ratio of the PWM control signal by a specified value. Thus, the output voltage of the inverter circuit section 21 reduces, and hence the output torque of the DC motor 30 reduces. As a result, the operation of the electric compressor 40 is controlled in the intermediate phase.

If the door of the refrigerator 50 is opened and closed or high-temperature food is injected into the refrigerator 50 under the operating state in the intermediate phase, a cooling operation load placed on the refrigerator 50 will increase. Thus, the torque output from the DC motor 30 is reduced with respect to the load, and therefore the phase detected by the phase difference detector 234 is a lagging phase. Therefore, the output voltage controller 232 increases the duty ratio of the PWM signal by a specified value. Thus, the output voltage of the inverter circuit section 21 increases, and hence the output torque of the DC motor 30 increases. As a result, the electric compressor 40 is operation-controlled in the intermediate phase.

In accordance with this, in the goods storage device such as the refrigerator 50 having the refrigeration cycle shown in FIG. 8B, the electric compressor 40 can be controlled well using the inverter control device 20 of the present embodiment, and hence, favorable system operation is attained. Thus, goods preserving temperature of the goods storage device can be stabilized, and hence goods can be stored with higher reliability.

### Embodiment 4

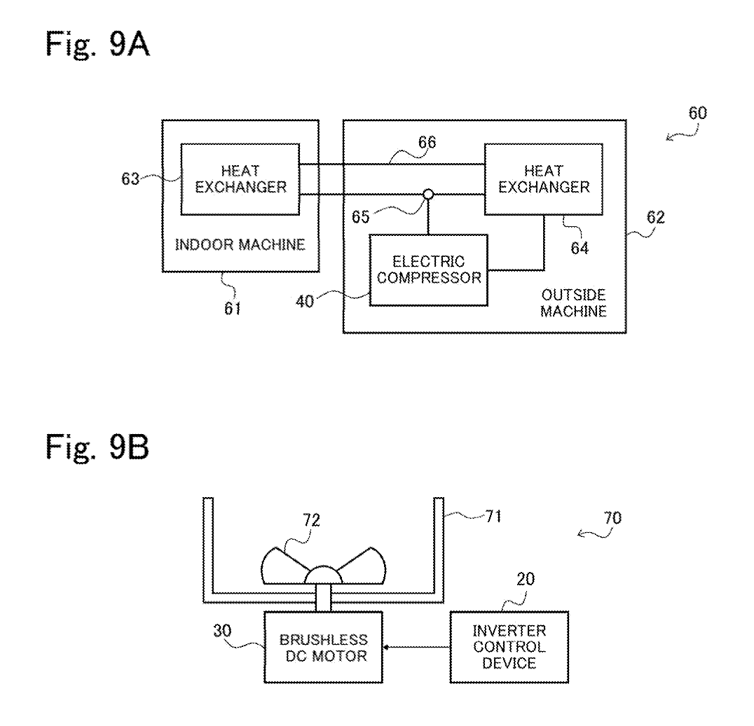

In Embodiment 3, the electric compressor 40 including the inverter control device 20 of Embodiment 1 or 2, and the refrigerator 50 including the electric compressor 40 have been described. The present invention is suitably applicable to electric equipment other than the refrigerator 50. In Embodiment 4, an example of the electric equipment other than the refrigerator 50 will be described with reference to FIGS. 9A and 9B.

[Exemplary Air-Conditioning Apparatus]

The electric compressor 40 of Embodiment 3 is suitably applied to electric equipment other than the refrigerator 50, for example, an air-conditioning apparatus. Specifically, as shown in FIG. 9A, an air-conditioning apparatus 60 of the present embodiment includes an indoor machine 61, an outside machine 62 and a pipe 66 connecting the indoor machine 61 and the outside machine 62 together. The indoor machine 61 includes a heat exchanger 63, while the outside machine 62 includes a heat exchanger 64 and the electric compressor 40 shown in FIG. 8A. Like the example shown in FIGS. 8A and 8B, in FIG. 9A, the indoor machine 61, the outside machine 62, and the heat exchangers 63; 64 are schematically represented by blocks.

The indoor machine 61 includes a blower fan, a temperature sensor, an operating unit, etc., which are not shown. In the same manner, the outside machine 62 includes an air blower, an accumulator, etc. The pipe 66 is provided with valves such as a pressure-reducing valve, a straightener, etc. A four-way valve 65 shown in FIG. 9A is one of the valves.

The heat exchanger 63 in the indoor machine 61 exchanges heat between inside air suctioned into the indoor machine 61 by the blower fan and cooling medium flowing in the interior of the heat exchanger 63. The indoor machine 61 supplies air warmed-up by the heat exchange to indoor area during warming, and supplies air cooled by the heat exchanger 63 to indoor area during cooling. The heat exchanger 64 in the outside machine 62 exchanges heat between outside air suctioned into the outside machine 62 by the blower and the cooling medium flowing in the interior of the heat exchanger 64.

The heat exchanger 63 in the indoor machine 61 and the heat exchanger 64 in the outside machine 62 are coupled together annularly by means of the pipe 66, thereby forming a refrigeration cycle. The pipe 66 coupling the heat exchangers 63, 64 is provided with the four-way valve 65 for switching between cooling and warming.

Specific configurations of the heat exchanger 63 or 64, the four-way valve 65, the blower fan, the temperature sensor, the operating unit, the blower, the accumulator, the valves, straightener, etc., are not particularly limited, but known configurations may be suitably used. In addition, the specific configurations of the indoor machine 61 and the outside machine 62 are not particularly limited, so long as the indoor machine 61 includes the heat exchanger 63 and the outside machine 62 includes the electric compressor 40 and the heat exchanger 64, various known configurations may be applicable to the heat exchanger 63 and the outside machine 62.

An exemplary operation of the air-conditioning apparatus 60 (refrigeration cycle) shown in FIG. 9A will be specifically described. In a cooling operation or a dehumidification operation, the electric compressor 40 of the outside machine 62 compresses the gaseous cooling medium and discharges the compressed gaseous cooling medium. The compressed gaseous cooling medium is output to the heat exchanger 64 of the outside machine 62 via the four-way valve 65. The heat exchanger 64 exchanges heat between the outside air and the gaseous cooling medium, and thereby the gaseous cooling medium is condensed to generate liquid. The liquefied cooling medium is pressure-reduced, and is output to the heat exchanger 63 of the indoor machine 61. In the heat exchanger 63, the liquefied cooling medium vaporizes by heat exchange with the inside air and turns to a gaseous cooling medium. The gaseous cooling medium returns to the electric compressor 40 of the outside machine 62 via the four-way valve 65. The electric compressor 40 compresses the gaseous cooling medium, and the compressed gaseous cooling medium is output to the heat exchanger 64 via the four-way valve 65.

In the warming operation, the electric compressor 40 of the outside machine 62 compresses the gaseous cooling medium and discharges the compressed gaseous cooling medium. The compressed gaseous cooling medium is output to the heat exchanger 63 of the indoor machine 61 via the four-way valve 65. The heat exchanger 63 exchanges heat between the gaseous cooling medium and the indoor air to condense the gaseous cooling medium to liquefied cooling medium. The liquefied cooling medium is pressure-reduced by a pressure-reducing valve and turns to a two-phase (gaseous-liquefied) cooling medium and output to the heat exchanger 64 of the outside machine 62. Since the heat exchanger 64 exchanges heat between outside air and the two-phase (gaseous-liquefied) cooling medium, the two-phase cooling medium vaporizes into a gaseous cooling medium, which returns to the electric compressor 40. The electric compressor 40 compresses the gaseous cooling medium and discharges the compressed gaseous cooling medium to the heat exchanger 63 of the indoor machine 61 via the four-way valve 65 again.

The air-conditioning apparatus 60 of the present embodiment has the above stated refrigeration cycle. The operation of the electric compressor 40 which constitute the refrigeration cycle can be controlled using the inverter control device 20 of Embodiment 1 or Embodiment 2. Since reliability of the electric compressor 40 constituting the refrigeration cycle is improved, the refrigeration cycle can be operated well. Therefore, air-conditioning in indoor area in buildings, vehicles, marine vessels, can be stabilized, and reliability of the air-conditioning apparatus 60, etc., can be improved.

[Exemplary Laundry Machine]

The inverter control device 20 of Embodiment 1 or 2 and the DC motor 30 controlled by the inverter control device 20, are widely suitably applied to electric equipment including motors in addition to the electric equipment including the electric compressor 40. Specific example of this may be application to a laundry machine 70, as shown in FIG. 9B.

The laundry machine 70 of the present embodiment includes the inverter control device 20 of Embodiment 1 or 2, the DC motor 30, a laundry sink 71, an agitating vane 72, a water supply section (not shown), an operating section (not shown), an outside casing (not shown), etc. The agitating vane 72 is provided inside of the laundry sink 71 to agitate water stored inside of the laundry sink 71. The laundry sink 71 is a tank into which clothes are injected and which washes the clothes. The laundry sink 71 is configured to store water containing a washing agent. Inside or the laundry sink 71, water is agitated by rotation of the agitating vane 72, and thereby the clothes are washed.

Specific configurations of the laundry sink 71, the agitating vane 72, the water supply section, the operating section, the outside casing, etc., are not particularly limited, and known configurations may be suitably used. Although the laundry machine 70 shown in FIG. 9B is configured to rotate the agitating vane 72 by the DC motor 30, the configuration of the laundry machine 70 of the present embodiment is not limited, but may be a drum-type laundry machine configured to rotate a rotary drum by the DC motor 30.

The laundry machine 70 of the present embodiment is configured to rotate the agitating vane 72 (or rotary drum, etc.) inside of the laundry sink 71 by the DC motor 30. The operation of the DC motor 30 is controlled by the inverter control device 20 of Embodiment 1 or 2. This allows the agitating wane 72 (or rotary drum, etc.) to be rotated stably. Therefore, reliability of the laundry machine 70 can be improved.

As described above, the present invention includes the electric compressor 40 including the DC motor 30 (see Embodiment 3), and whose operation is controlled by the inverter control device 20 of Embodiment 1 or 2. In the electric compressor 40, the DC motor 30 can operate with higher efficiency when the rotational number is relatively lower, and operate with higher torque when the rotational number is relatively higher. If the electric compressor 40 of the present embodiment is applied to the refrigerator 50 (see Embodiment 3) or the air-conditioning apparatus 60, stable compression operation can be achieved and its reliability can be improved, even when a load fluctuation occurs in the refrigeration cycle.

Therefore, the present invention includes the electric equipment such as the refrigerator 50 including the electric compressor 40, the air-conditioning apparatus 60, etc. Furthermore, the present invention includes the electric equipment which does not include the electric compressor 40 but includes the DC motor 30, and whose operation is controlled by the inverter control device 20 of Embodiment 1 or 2, like the laundry machine 70. Such electric equipment can expand an operation range with higher efficiency, because the DC motor 30 is controlled by the inverter control device 20. In addition, reliability of the DC motor 30 and the electric compressor 40, and reliability of the electric equipment including the DC motor 30 and the electric compressor 40 can be improved.

In the present embodiment, like Embodiment 3, an output voltage controller 232 in the inverter control device 20 generates the output voltage control signal to change or maintain the three-phase voltage output from the inverter circuit section 21 according to the phase difference of the induced voltage detected by the phase difference detector 234.

Specifically, in the electric equipment such as the refrigerator 50 of Embodiment 3, the air-conditioning apparatus 60 of Embodiment 4, the laundry machine 70 of Embodiment 4, etc., if the phase difference of the induced voltage detected by the phase difference detector 234 is the leading phase, the output voltage controller 232 generates the output voltage control signal to reduce the three-phase voltage output from the inverter circuit section 21. Or, if the phase difference of the induced voltage detected by the phase difference detector 234 is the lagging phase, the output voltage controller 232 generates the output voltage control signal to increase the three-phase voltage output from the inverter circuit section 21. Or, if the phase difference of the induced voltage detected by the phase difference detector 234 is the intermediate phase, the output voltage controller 232 generates the output voltage control signal to maintain (not to change) the three-phase voltage output from the inverter circuit section 21.

### Comparative Embodiment

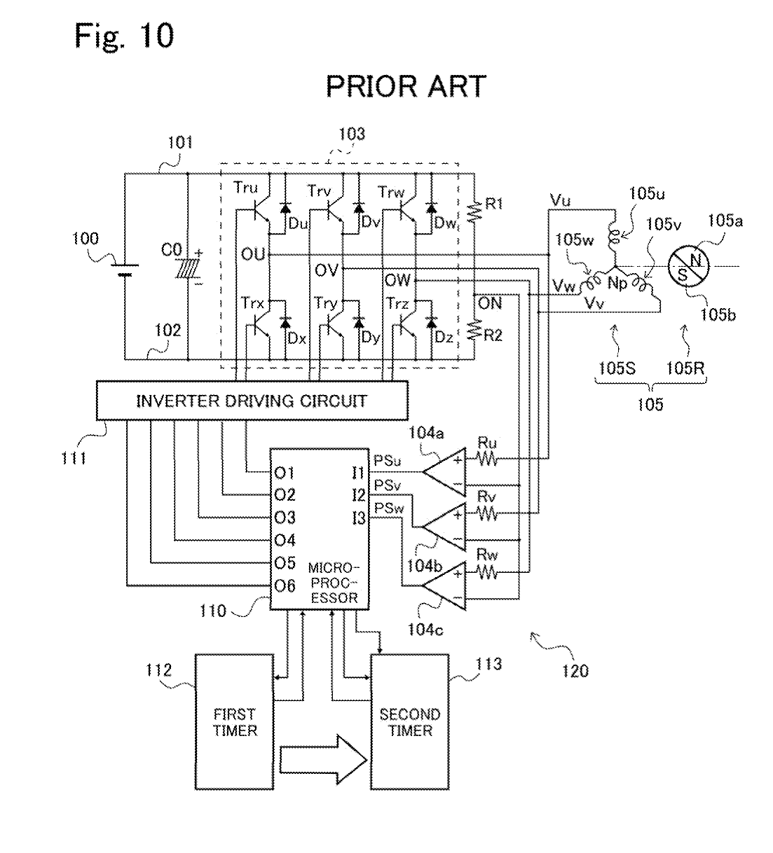

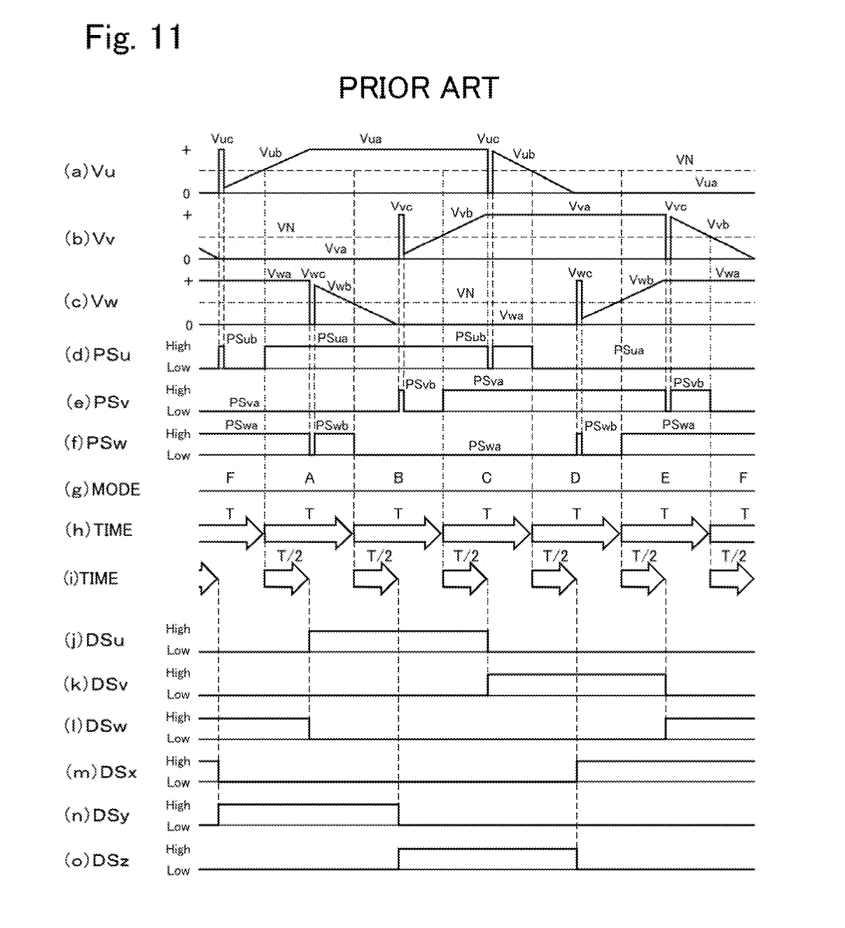

Next, a description will be given of a configuration of a conventional inverter control device disclosed in Japanese Laid-Open Patent Application Publication No. Hei. 1-8890 with reference to FIGS. 10 and 11, in comparison with the inverter control device 20 of Embodiment 1 or 2.

Referring to FIG. 10, in a conventional inverter control device 120, three pairs of switching transistors Tru, Trx, Try, Try, Trw and Trz, are coupled together to form a three-phase bridge between terminals of a DC electric power supply 100, thereby constituting an inverter circuit section 103. A brushless DC motor 105 includes a stator 105S having four-polar winding structure and a rotor 105R. The rotor 105R has a magnet-embedded structure in which permanent magnets 105a, 105b are embedded therein. Alternatively, the rotor 105R may have a surface magnet structure in which the permanent magnets 105a, 105b are disposed on a surface thereof. The stator 105S is composed of stator windings 105u, 105v and 105w connected in Y-shape.

The switching transistors Tru, Trx, Trv, Try, Trw and Trz, are configured in such a manner, the switching transistors Tru and Trx are connected in series via an output terminal OU to form a pair, the switching transistors Try and Try are connected in series via an output terminal OV to form a pair, and the switching transistors Trw and Trz are connected in series via an output terminal OW to form a pair. The output terminals OU, OV and OW are connected to the stator windings 105u, 105v and 105w of the DC motor 105, respectively. The switching transistors Tru, Trx, Try, Try, Trw and Trz, are configured in such a manner that each of protective six freewheeling diodes Du, Dx, Dv, Dy, Dw and Dz is connected between a collector and an emitter of the corresponding one of the switching transistors Tru, Trx, Try, Try, Trw and Trz.

Resistors R1, R2 are connected in series via a detection terminal ON between buses 101, 102. The detection terminal ON outputs a virtual neutral point voltage value VN. The virtual neutral point voltage value VN corresponds a voltage at a neutral point Np of the stator windings 105u, 105v and 105w of the DC motor 105, and is a value which is equal to ½ of the output voltage of a DC electric power supply 100. A capacitor C0 is coupled in parallel with the three-phase bridge structure between the buses 101, 102.

A non-inverting input terminal (+) of a comparator 104a is connected to the output terminal OU via the resistor Ru, and an inverting input terminal (−) thereof is connected to the detection terminal ON. A non-inverting input terminal (+) of a comparator 104b is connected to the output terminal OV via the resistor Rv, and an inverting input terminal (−) thereof is connected to the detection terminal ON. A non-inverting input terminal (+) of a comparator 104c is connected to the output terminal OW via the resistor Rw, and an inverting input terminal (−) thereof is connected to the detection terminal ON.

The output terminals of the comparators 104a, 104b and 104c are connected to input terminals 11, 12 and 13 of a microprocessor 110 which is logic means. Output terminals O1 to O6 of the microprocessor 110 are connected to the inverter circuit section 103 via an inverter driving circuit 111 to control the switch transistors Tru, Trx, Trv, Try, Trw, Trz. The microprocessor 110 is also connected to a first timer 112 and to a second timer 113.

Next, a description will be given of the operation control of the DC motor 105 by the conventional inverter control device 120, with reference to the flowchart of FIG. 11.

Referring to FIG. 11, (a) Vu indicates the waveform of the terminal voltage Vu of the stator winding 105u in the DC motor 105 in a steady operation state, (b) Vv indicates the waveform of the terminal voltage Vv of the stator winding 105v in the DC motor 105 in a steady operation state, and (c) Vw indicates the waveform of the terminal voltage Vw of the stator winding 105w in the DC motor 105 in a steady operation state.

As shown in FIG. 11, the waveform of the terminal voltage Vu is a composite waveform of a supply voltage (output voltage) Vua from the inverter circuit section 103, an induced voltage Vub generated in the stator winding 105u, and a spike voltage Vuc generated during commutation control. The waveform of the terminal voltage Vv is a composite waveform of a supply voltage (output voltage) Vva from the inverter circuit section 103, an induced voltage Vvb generated in the stator winding 105v, and a spike voltage Vvc generated during commutation control. The waveform of the terminal voltage Vw is a composite waveform of a supply voltage (output voltage) Vwa from the inverter circuit section 103, an induced voltage Vwb generated in the stator winding 105w, and a spike voltage Vwc generated during commutation control. The spike voltage Vuc, Vvc or Vwc is a pulse waveform generated in a state in which any of the freewheeling diodes Du, Dx, Dv. Dy, Dw and Dz, is in a conductive state during commutation of the switching transistors Tru, Trx, Try. Try, Trw and Trz.

As shown in FIG. 11, (d)PSu indicates an output signal of the comparator 104a. The output signal PSu is a voltage value indicating a result of a comparison between the terminal voltage Vu and the virtual neutral point voltage value VN (value which is equal to ½ of the output voltage of the DC electric power supply 100). As shown in FIG. 11, (e)PSv indicates the output signal of the comparator 104b. The output signal PSv is a voltage value indicating a result of a comparison between the terminal voltage Vv and the virtual neutral point voltage value VN (value which is equal to ½ of the output voltage of the DC electric power supply 100). As shown in FIG. 11, (f)PSw indicates the output signal of the comparator 104e. The output signal PSw is a voltage value indicating a result of a comparison between the terminal voltage Vw and the virtual neutral point voltage value VN (value which is equal to ½ of the output voltage of the DC electric power supply 100).

The waveform of the output signal PSu is a composite waveform of a signal PSua and a signal PSub. The waveform of the output signal PSv is a Composite waveform of a signal PSva and a signal PSvb. The waveform of the output signal PSw is a composite waveform of a signal PSwa and a signal PSwb. The signal PSua, PSva or PSwa indicates the positive/negative sign and phase of the induced voltage Vub, Vvb or Vwb, while the signal PSub, PSvb or PSwb indicates the signal corresponding to the pulse voltage Vu, Vvc or Vwc, respectively.

The pulse voltages Vuc, Vvc and Vwc are ignored by wait timers, and therefore the output signal PSu, PSv or PSw indicates the positive/negative sign and phase of the voltage Vub, Vvb or Vwb.

In FIG. 11, (g) indicates six kinds modes A to F which are identified by the microprocessor 110. (h) TIME indicates a time T corresponding to a length of each of modes A to F. This time T corresponds to an electric angle of 60 degrees. (i) TIME is delay time T/2 and corresponds to an electric angle of 30 degrees. (j)DSu, (k) DSv, (l) DSw, (m)DSx, (n)DSy and (o)DSz are drive signals of the switching transistors Tru, Trv, Trw, Trx, Try and Trz, respectively.

The microprocessor 110 identities the six modes A to F indicated by (g)MODE based on the states of the signals PSu, PSv and PSw output from the comparators 104a, 104b and 104c. Then, the microprocessor 110 outputs the drive signals indicated by (j) to (o) at timings retarded (delayed) with a delay time T/2 (electric angle 30 degrees) from a time point when the levels of the output signals PSu, PSv and PSw have changed.

As should be appreciated from the above, the conventional inverter control device 120 detects the position of the rotor 105R based on the induced voltages generated in the stator windings 105u, 105v and 105w according to the rotation of the rotor 105R of the DC motor 105. In addition, according to the detection of the position state, the inverter control device 120 detects change times (T) of the corresponding induced voltages, thereby controlling current-applying modes and timings of current application of the stator windings 105u, 105v, 105w. In brief, the inverter control device 120 decides the drive signals for driving current application to the stator windings 105u, 105v and 105w, based on the induced voltages of the DC motor 105, and controls the operation of the DC motor 105 based on the drive signals.

However, in the inverter control device 120, there exists a problem that the commutation control is restricted to a range in which the induced voltage can be monitored. In addition, if a load fluctuation or voltage fluctuation which causes a rapid rotational fluctuation of the DC motor 105, takes place, it becomes difficult to detect a zero cross point in the waveform of the induced voltage. Because of this, it is more likely that the relative position of the rotor 1058 cannot be identified, and the DC motor 30 comes out of synchronism (step out) and stop.

In contrast, in the inverter control device of Embodiment 1 or 2, even if it becomes difficult to detect the magnetic polar position (rotor position) from the waveform of the induced voltage due to a fluctuation on the rotational speed command or the output torque, the DC motor can be switched from the position detection commutation control to the forced synchronization commutation control. This allows the operating state of the DC motor to be forcibly continued. Therefore, it is possible to effectively reduce a chance that the DC motor will come out of synchronism (step out) and stop, due to a change in the operating state.

In the forced synchronization commutation control, the inverter circuit section can output a voltage with a frequency forcibly synchronized by the synchronization operation. This makes it possible to reduce magnetic flux of the stator windings of U-phase, V-phase, and W-phase and reduce the induced voltages. In this way, it becomes possible to increase the motor current of the DC motor and increase the output torque. Because of this, a range of the operation control of the DC motor can be expanded.

In accordance with the present invention, in the sensorless inverter control device which controls the operation of the DC motor, it is possible to effectively reduce a chance that the DC motor will come out of synchronism (step out) and stop, and hence implement operation control which is more stable and more reliable.

As should be appreciated from the forgoing, the present invention is widely suitably applied to fields in which the operation of brushless DC motors is controlled sensorlessly. Furthermore, the present invention is suitably applied to an electric compressor including a brushless DC motor whose operation is controlled sensorlessly, household equipment such as a refrigerator, an air-conditioning apparatus, or a laundry machine including the DC motor or the electric compressor, etc., or electric vehicles.

Numeral modifications and alternative embodiments of the present invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

What is claimed is:

1. An inverter control device comprising:
an inverter circuit section for driving a brushless DC motor which is a three-phase permanent magnet synchronous motor;
a rotor position signal generating circuit section which compares an induced voltage of the brushless DC motor to a reference voltage and generates a rotor position signal; and
an inverter control section which generates a control signal using the rotor position signal from the rotor position signal generating circuit section and outputs the control signal to the inverter circuit section;
wherein the inverter control section includes:
an output voltage controller which generates an output voltage control signal for controlling a three-phase voltage output from the inverter circuit section;
a rotor position detector for detecting a position of a rotor of the brushless DC motor based on the rotor position signal;
a phase difference detector for detecting a phase difference of a phase of the induced voltage with respect to a phase of the output voltage of the inverter circuit section, based on the rotor position signal from the rotor position signal generating circuit section;
a position detection commutation controller which generates a position detection commutation signal for commutating a plurality of switching elements included in the inverter circuit section, based on the detected rotor position signal from the rotor position detector;
a forced synchronization commutation controller which generates a forced synchronization commutation signal for forcibly commutating the plurality of switching elements, based on a target value of a rotational speed of the brushless DC motor, and the phase difference detected by the phase difference detector; and
a rotational speed detector for detecting a rotational speed of the brushless DC motor in operation;
a driving controller for controlling the output voltage of the inverter circuit section based on the output voltage control signal and controlling commutation of the plurality of switching elements based on the position detection commutation signal or the forced synchronization commutation signal; and
wherein the driving controller switches the commutation of the plurality of switching elements from control based on the position detection commutation signal to control based on the forced synchronization commutation signal, if the output voltage of the inverter circuit section is equal to or greater than a preset threshold and a detected value of the rotational speed which is detected by the rotational speed detector is equal to less than a reference value less than the target value of the rotational speed; and
the output voltage controller changes the output voltage control signal based on the phase difference detected by the phase difference detector, during a period when the driving controller is controlling the commutation of the plurality of switching elements based on the forced synchronization commutation signal.

2. The inverter control device according to claim 1,
wherein the output voltage controller changes the output voltage control signal to adjust the phase of the induced voltage to enable the rotor position detector to detect the position of the rotor, if the target value of the rotational speed becomes equal to or less than a preset lower limit value during a period when the driving controller is controlling the commutation of the plurality of switching elements based on the forced synchronization commutation signal; and
the driving controller switches the commutation of the plurality of switching elements from the control based on the forced synchronization commutation signal to the control based on the position detection commutation signal, after the phase of induced voltage changes.

3. The inverter control device according to claim 1.
wherein the output voltage controller generates the output voltage control signal to decrease the three-phase voltage output from the inverter circuit section, if the phase difference of the induced voltage which is detected by the phase difference detector is a leading phase.

4. The inverter control device according to claim 1
wherein the output voltage controller generates the output voltage control signal to increase the three-phase voltage output from the inverter circuit section, if the phase difference of the induced voltage which is detected by the phase difference detector is a lagging phase.

5. The inverter control device according to claim 1,
wherein the output voltage controller generates the output voltage control signal to maintain the three-phase voltage output from the inverter circuit section, if the phase difference of the induced voltage which is detected by the phase difference detector is an intermediate phase.

6. An electric compressor comprising:
an inverter control device comprising an inverter circuit section for driving a brushless DC motor which is a three-phase permanent magnet synchronous motor; a rotor position signal generating circuit section which compares an induced voltage of the brushless DC motor to a reference voltage and generates a rotor position signal; and an inverter control section which generates a control signal using the rotor position signal from the rotor position signal generating circuit section and outputs the control signal to the inverter circuit section; wherein the inverter control section includes: an output voltage controller which generates an output voltage control signal for controlling a three-phase voltage output from the inverter circuit section; a rotor position detector for detecting a position of a rotor of the brushless DC motor based on the rotor position signal; a phase difference detector for detecting a phase difference of a phase of the induced voltage with respect to a phase of the output voltage of the inverter circuit section, based on the rotor position signal from the rotor position signal generating circuit section; a position detection commutation controller which generates a position detection commutation signal for commutating a plurality of switching elements included in the inverter circuit section, based on the detected rotor position signal from the rotor position detector; a forced synchronization commutation controller which generates a forced synchronization commutation signal for forcibly commutating the plurality of switching elements, based on a target value of a rotational speed of the brushless DC motor, and the phase difference detected by the phase difference detector; a rotational speed detector for detecting a rotational speed of the brushless DC motor in operation; and a driving controller for controlling the output voltage of the inverter circuit section based on the output voltage control signal and controlling commutation of the plurality of switching elements based on the position detection commutation signal or the forced synchronization commutation signal; and wherein the driving controller switches the commutation of the plurality of switching elements from control based on the position detection commutation signal to control based on the forced synchronization commutation signal, if the output voltage of the inverter circuit section is equal to or greater than a preset threshold and a detected value of the rotational speed which is detected by the rotational speed detector is equal to less than a reference value less than the target value of the rotational speed; and the output voltage controller changes the output voltage control signal based on the phase difference detected by the phase difference detector, during a period when the driving controller is controlling the commutation oldie plurality of switching elements based on the forced synchronization commutation signal;
the brushless DC motor controlled by the inverter control device; and
a compression mechanism for compressing a heat transmission medium.

7. Electric equipment comprising:
an inverter control device comprising an inverter circuit section for driving a brushless DC motor which is a three-phase permanent magnet synchronous motor; a rotor position signal generating circuit section which compares an induced voltage of the brushless DC motor to a reference voltage and generates a rotor position signal; and an inverter control section which generates a control signal using the rotor position signal from the rotor position signal generating circuit section and outputs the control signal to the inverter circuit section; wherein the inverter control section includes: an output voltage controller which generates an output voltage control signal for controlling a three-phase voltage output from the inverter circuit section; a rotor position detector for detecting a position of a rotor of the brushless DC motor based on the rotor position signal; a phase difference detector for detecting a phase difference of a phase of the induced voltage with respect to a phase of the output voltage of the inverter circuit section, based on the rotor position signal from the rotor position signal generating circuit section; a position detection commutation controller which generates a position detection commutation signal for commutating a plurality of switching elements included in the inverter circuit section, based on the detected rotor position signal from the rotor position detector; a forced synchronization commutation controller which generates a forced synchronization commutation signal for forcibly commutating the plurality of switching elements, based on a target value of a rotational speed of the brushless DC motor, and the phase difference detected by the phase difference detector; a rotational speed detector for detecting a rotational speed of the brushless DC motor in operation; and a driving controller for controlling the output voltage of the inverter circuit section based on the output voltage control signal and controlling commutation of the plurality of switching elements based on the position detection commutation signal or the forced synchronization commutation signal; and wherein the driving controller switches the commutation of the plurality of switching elements from control based on the position detection commutation signal to control based on the forced synchronization commutation signal, if the output voltage of the inverter circuit section is equal to or greater than a preset threshold and a detected value of the rotational speed which is detected by the rotational speed detector is equal to less than a reference value less than the target value of the rotational speed; and the output voltage controller changes the output voltage control signal based on the phase difference detected by the phase difference detector, during a period when the driving controller is controlling the commutation of the plurality of switching elements based on the forced synchronization commutation signal; and
the brushless DC motor controlled by the inverter control device.
